(19) United States
(12) Patent Application Publication
(10) Pub. No.: US 2023/0008420 A1
(43) Pub. Date: Jan. 12, 2023

(54) Ion Funnels Having Improved Pressure Distribution and Flow Characteristics

(71) Applicant: MOBILion Systems, Inc., Chadds Ford, PA (US)

(72) Inventors: Serguei Krioutchkov, Calgary (CA); John Daniel DeBord, West Grove, PA (US); Liulin Deng, Chester Springs, PA (US); Sidney E. Buttrill, JR., Palo Alto, CA (US); Myles Elliott Levine, Avondale, PA (US); Nathan Paul Roehr, Willmington, DE (US)

(73) Assignee: MOBILion Systems, Inc., Chadds Ford, PA (US)

(21) Appl. No.: 17/852,674

(22) Filed: Jun. 29, 2022

Related U.S. Application Data
(60) Provisional application No. 63/216,760, filed on Jun. 30, 2021.

(51) Int. Cl. H01J 49/06; G01N 27/622; H01J 49/02

(52) U.S. Cl. CPC H01J 49/066; G01N 27/622; H01J 49/022

(57) ABSTRACT

The present disclosure is directed to an ion funnel and associated systems, where the ion funnel includes a plurality of electrodes each define an opening having an associated inner dimension and receive a RF voltage. The associated inner dimensions progressively reduce in size from approximately a first inner dimension to approximately a second inner dimension. The electrodes define an internal chamber having an outer dimension that reduces at a convergence angle of approximately 30 degrees for at least a majority of a length of the internal chamber from the first inner dimension to the second inner dimension. Additional systems and methods are provided for transferring ions from an ion funnel to an ion mobility device having a pressure greater than that of the ion funnel, for selectively transferring ions from the ion funnel to the ion mobility device, and for stripping ions of certain molecules adducted thereto during transfer.

### CROSS-REFERENCE TO RELATED APPLICATIONS

The present application claims the benefit of priority to U.S. Provisional Patent Application No. 63/216,760 filed on Jun. 30, 2021, which is incorporated herein by reference in its entirety.

### BACKGROUND

### Technical Field

The present disclosure relates generally to ion funnels used in the field of mass spectrometry (MS). More specifically, the present disclosure relates to ion funnels that have improved pressure distribution and flow characteristics.

### Related Art

Ion funnels can be implemented in MS systems to focus, direct, and transport ions from an ionization source to an ion manipulation device. Such ion funnels can receive a stream of ions from an ionization source, e.g., an electrospray ionizer, through a capillary that discharges the ions into the ion funnel as a fine aerosol within a gas. One such prior art ion funnel is shown and described in U.S. Pat. No. 6,107,628, entitled “Method and Apparatus for Direction Ions and Other Charged Particles Generated at Near Atmospheric Pressures into a Region Under Vacuum,” the disclosure of which is incorporated herein by reference. The ion funnel's function is to transfer the ions while allowing the gas to be removed, e.g., by a pump, so that only the ions are transferred to the associated ion manipulation device. However, the gas within prior art ion funnels can have high internal turbulence that can result in the loss of ions or time varying fluctuations in fluence, e.g., the number of ions that exit the ion detector per unit time, that translates into signal instability downstream of the ion funnel, e.g., at a downstream ion detector.

Some prior art ion funnels utilize apertured diaphragms to assist with the escape of gas from the ion funnel and overcome some shortcomings of other prior art ion funnels. One such example is U.S. Pat. No. 7,064,321, entitled “Ion Funnel With Improved Ion Screening,” the disclosure of which is incorporated herein by reference.

Some other prior art systems implement two ion funnels in series. In particular, such systems are known to sequentially combine two ion funnels in separate vacuum regions or chambers in an attempt to reduce flow effects. However, such systems often require additional electronics, mechanical elements, and space to implement compared to single ion funnel implementations. It is also known to implement ion funnel traps as a second stage in such two ion funnel systems, e.g., in the second ion funnel after the initial first ion funnel. The ion funnel traps are utilized to packetize ions prior to downstream analysis. One exemplary two-stage ion funnel that utilizes an ion trap is U.S. Pat. No. 7,888,635 entitled “Ion Funnel Ion Trap and Process,” the disclosure of which is incorporated herein by reference. However, such ion funnels do not cure the foregoing shortcomings.

Accordingly, there is a need for ion funnels with improved pressure distribution and flow characteristics, and enhanced flow interaction with downstream devices across a wide range of capillary gas flow rates.

### SUMMARY

The present disclosure relates to ion funnels having improved pressure distribution and flow characteristics.

In accordance with embodiments of the present disclosure, an ion funnel includes an entrance electrode, a last electrode, and a plurality of intermediate electrodes. The entrance electrode defines a first opening having a first inner dimension, and the last electrode defines a second opening having a second inner dimension that is smaller than the first inner dimension. The plurality of intermediate electrodes are positioned between the entrance electrode and the last electrode, and each define an associated opening having an associated inner dimension, which progressively reduce in size from approximately the first inner dimension to approximately the second inner dimension. The ion funnel also includes an internal chamber defined by the first opening, the associated openings of the plurality of intermediate electrodes, and the second opening. The internal chamber has an outer dimension that reduces at a convergence angle from the first inner dimension to the second inner dimension. The convergence angle is less than 30 degrees for at least a majority of a length of the internal chamber. At least a portion of the plurality of intermediate electrodes receive a radio frequency (RF) voltage that is configured to confine ions received by the ion funnel.

In some aspects, the first opening, the second opening, and the associated openings can be circular, while in other aspects they can each include a center point such that the center points are substantially in a straight line.

In some aspects, at least a portion of the plurality of intermediate electrodes can receive a direct current (DC) voltage configured to control the urge the ions toward the last electrode.

In some aspects, the ion funnel can include a space between each of the plurality of intermediate electrodes that is configured to permit gas to be extracted from the ion funnel.

In other aspects, the ion funnel can include a conductance limit having an orifice. The conductance limit can be positioned adjacent the last electrode and can separate the ion funnel from a downstream device having a pressure greater than a pressure of the ion funnel, which can cause gas from the downstream device to enter the ion funnel. In such aspects, the ion funnel can be configured to generate an electric field that urges the ions through the orifice of the conductance limit and causes the ions to enter the downstream device. The downstream device can be an ion mobility device, for example.

In still other aspects, each of the plurality of intermediate electrodes can be slanted at an angle with respect to a central axis of the ion funnel that is greater than or less than 90 degrees.

In accordance with another embodiment of the present disclosure, an ion mobility system includes an ionization source including a capillary configured to discharge a stream of gas and ions, an ion funnel, a conductance limit including an orifice, and an ion mobility device positioned adjacent to the conductance limit. The ion funnel is configured to receive the stream of gas and ions from the capillary, and includes a plurality of electrodes positioned between an entrance electrode and a last electrode. The entrance electrode defines a first opening having a first inner dimension, the last electrode defines a second opening having a second inner dimension, and the plurality of electrodes each define an associated central opening having an associated inner diameter. The associated inner dimension progressively reduce in size from approximately the first inner dimension to approximately the second inner dimension. The conductance limit is positioned adjacent the last electrode. At least a portion of the plurality of electrodes receive a RF voltage that is configured to confine the ions received by the ion funnel. A pressure of the ion mobility device is greater than a pressure of the ion funnel, which causes gas from the ion mobility device to enter the ion funnel through the orifice of the conductance limit.

In some aspects, the first opening, the second opening, and the associated openings can be circular, while in other aspects they can each include a center point such that the center points are substantially in a straight line.

In some aspects, at least a portion of the plurality of electrodes can receive a direct current (DC) voltage and generate a DC voltage gradient that is configured to urge the ions received by the ion funnel toward the conductance limit. The conductance limit can also receive a predetermined voltage bias that causes ions having less than a predetermined collision cross-section to overcome the pressure of the ion mobility device and enter the ion mobility device through the conductance limit orifice. The voltage bias can be applied by a controller and can be adjustable by the controller. The controller can also be configured to adjust the voltage bias to a second predetermined voltage to cause ions having less than a second predetermined collision cross-section to overcome the pressure of the ion mobility device and enter the ion mobility device through the conductance limit orifice.

In some aspects, the ion mobility system can include a vacuum system, and the ion funnel can be positioned within a vacuum chamber with which the vacuum system is in fluidic communication. The vacuum system can be configured to maintain the vacuum chamber at a first pressure and remove gas from the vacuum chamber. Optionally, the vacuum system can also be in fluidic communication with a second vacuum chamber in which the ion mobility device is positioned and can be configured to maintain the second vacuum chamber at a second pressure.

In other aspects, the gas entering the ion funnel from the ion mobility device can flow in a direction that is generally opposite the direction of ion travel through the ion funnel and cause the ions to collide with the gas and strip the ions of salts, water, or solvent molecules adducted to the ions.

In some other aspects, the ion funnel can include an internal chamber defined by the first opening, the associated openings of the plurality of electrodes, and the second opening. The internal chamber can have an outer dimension that reduces at a convergence angle from the first inner dimension to the second inner dimension. In such aspects, the convergence angle can be less than 30 degrees for at least a majority of a length of the internal chamber.

In still other aspects, each of the electrodes can define a slope parameter with respect to an adjacent electrode. The slope parameter can be defined as half the difference between the respective inner dimension of the associated opening of the electrode and the adjacent electrode divided by a distance between the electrode and the adjacent electrode. The slope parameter for a majority of the electrodes with respect to the respective adjacent electrode can be less than 0.27.

In some aspects, the ion funnel can include a space between each of the plurality of electrodes that is configured to permit gas to be extracted from the ion funnel.

In some other aspects, each of the plurality of electrodes can be slanted at an angle with respect to a central axis of the ion funnel that is greater than or less than 90 degrees.

In still other aspects, the system can include a second ion funnel configured to receive the stream of gas and ions from the first ion funnel. The second ion funnel can include a second plurality of electrodes positioned between a second entrance electrode defining a third opening having a third inner dimension and a second last electrode defining a fourth opening having a fourth inner dimension. Each of the second plurality of electrodes can define an associated opening having an associated inner dimension, with the associated inner dimensions of the second plurality of electrodes progressively reducing in size from approximately the third inner dimension to approximately the fourth inner dimension. The second ion funnel can include an internal chamber defined by the third opening, the associated openings of the second plurality of electrodes, and the fourth opening. The internal chamber can have an outer dimension reducing at a convergence angle from the third inner dimension to the fourth inner dimension. In such aspects, the convergence angle can be less than 30 degrees for at least a majority of a length of the internal chamber.

In accordance with another embodiment of the present disclosure, a method of transferring ions from an ion funnel to an ion mobility device includes discharging a stream of gas and ions into the ion funnel that includes a plurality of electrodes positioned between an entrance electrode and a last electrode. The entrance electrode defines a first opening having a first inner dimension, the last electrode defines a second opening having a second inner dimension, and the plurality of electrodes each define an associated central opening having an associated inner dimension. The associated inner dimensions progressively reduce in size from approximately the first inner dimension to approximately the second inner dimension. The method additionally involves applying a RF voltage to at least a portion of the plurality of electrodes, which confines the ions received by the ion funnel within the plurality of electrodes. The method also involves maintaining the ion funnel substantially at a first pressure and maintaining an ion mobility device substantially at a second pressure that is greater than the first pressure. The method additionally includes causing gas from the ion mobility device to enter the ion funnel through an orifice of a conductance limit positioned between the ion funnel and the ion mobility device.

In some aspects, the first opening, the second opening, and the associated openings can be circular, while in other aspects they can each include a center point such that the center points are substantially in a straight line.

In other aspects, the method can further include applying a DC voltage to at least a portion of the plurality of electrodes. Such aspects can also involve generating by at least the portion of the plurality of electrodes receiving the DC voltage a DC voltage gradient that is configured to urge the ions received by the ion funnel toward the conductance limit.

In some aspects, the method can further include causing ions having less than a predetermined collision cross-section to overcome the pressure of the ion mobility device and enter the ion mobility device through the conductance limit orifice by applying a predetermined voltage bias to the conductance limit. Such aspects can also involve causing ions having less than a second predetermined collision cross-section to overcome the pressure of the ion mobility device and enter the ion mobility device through the conductance limit orifice by adjusting the predetermined voltage bias applied to the conductance limit to a second predetermined voltage bias. Such aspects can additionally and/or alternatively involve causing the ions to collide with the gas entering the ion funnel from the ion mobility device and strip the ions of salts, water, or solvent molecules adducted to the ions. In such aspects, the gas entering the ion funnel from the ion mobility device can flow in a direction that is generally opposite the direction of ion travel through the ion funnel.

In other aspects, the ion funnel can include an internal chamber defined by the first opening, the associated openings of the plurality of electrodes, and the second opening. The internal chamber can have an outer dimension that reduces at a convergence angle from the first inner dimension to the second inner dimension. In such aspects, the convergence angle can be less than 30 degrees for at least a majority of a length of the internal chamber.

In still other aspects, each of the electrodes can define a slope parameter with respect to an adjacent electrode. The slope parameter can be defined as half the difference between the respective inner dimension of the associated opening of the electrode and the adjacent electrode divided by a distance between the electrode and the adjacent electrode. The slope parameter for a majority of the electrodes can be less than 0.27.

In some aspects, the ion funnel can include a space between each of the plurality of electrodes that is configured to permit gas to be extracted from the ion funnel.

In some other aspects, each of the plurality of electrodes can be slanted at an angle with respect to a central axis of the ion funnel that is greater than or less than 90 degrees.

In some aspects, the stream of ions can be discharged into the ion funnel by a capillary, while in other aspects the stream of ions can be discharged into the ion funnel by a second ion funnel. In such aspects, the second ion funnel can include a second plurality of electrodes positioned between a second entrance electrode and a second last electrode. The second entrance electrode defines a third opening having a third inner dimension, the second last electrode defines a fourth opening having a fourth inner dimension, and the second plurality of electrodes each define an associated opening having an associated inner dimension, such that the associated inner dimensions of the second plurality of electrodes progressively reduce in size from approximately the third inner dimension to approximately the fourth inner dimension. The second ion funnel can include an internal chamber defined by the third opening, the associated openings of the second plurality of electrodes, and the fourth opening. The internal chamber can have an outer dimension that reduces at a convergence angle from the third inner dimension to the fourth inner dimension. In such aspects, the convergence angle can be less than 30 degrees for at least a majority of a length of the internal chamber.

In accordance with embodiments of the present disclosure, an ion funnel includes an entrance electrode, a last electrode, and a plurality of intermediate electrodes. The entrance electrode defines a first opening having a first inner dimension, and the last electrode defines a second opening having a second inner dimension that is smaller than the first inner dimension. The plurality of intermediate electrodes are positioned between the entrance electrode and the last electrode, and each define an associated opening having an associated inner dimension, which progressively reduce in size from approximately the first inner dimension to approximately the second inner dimension. Each of the intermediate electrodes defines a slope parameter with respect to an adjacent intermediate electrode, which is defined as half the difference between the associated inner dimension of the intermediate electrode and the associated inner dimension of the adjacent intermediate electrode divided by a distance between the intermediate electrode and the adjacent intermediate electrode. The slope parameter of at least a majority of the intermediate electrodes with respect to the respective adjacent electrode is less than 0.27. At least a portion of the plurality of intermediate electrodes receive a radio frequency (RF) voltage that is configured to confine ions received by the ion funnel within the plurality of intermediate electrodes.

In some aspects, the ion funnel can include a second slope parameter, which can be defined as half the difference between the first inner dimension and the second inner dimension divided by the distance between the entrance electrode and the last electrode. The second slope parameter can be less than 0.27.

In some other aspects, the ion funnel can also include an internal chamber defined by the first opening, the associated openings of the plurality of intermediate electrodes, and the second opening. The internal chamber can have an outer dimension that reduces at a convergence angle from the first inner dimension to the second inner dimension. The convergence angle can be less than 30 degrees for at least a majority of a length of the internal chamber.

In other aspects, the first opening, the second opening, and the associated openings can be circular, while in other aspects they can each include a center point such that the center points are substantially in a straight line.

In some aspects, at least a portion of the plurality of intermediate electrodes can receive a direct current (DC) voltage configured to control the motion of the ions confined within the ion funnel.

In some aspects, the ion funnel can include a space between each of the plurality of intermediate electrodes that is configured to permit gas to be extracted from the ion funnel.

In other aspects, the ion funnel can include a conductance limit having an orifice. The conductance limit can be positioned adjacent the last electrode and can separate the ion funnel from a downstream device having a pressure greater than a pressure of the ion funnel, which can cause gas from the downstream device to enter the ion funnel. In such aspects, the ion funnel can be configured to generate an electric field that urges the ions through the orifice of the conductance limit and causes the ions to enter the downstream device. The downstream device can be an ion mobility device, for example.

In still other aspects, each of the plurality of intermediate electrodes can be slanted at an angle with respect to a central axis of the ion funnel that is greater than or less than 90 degrees.

In accordance with embodiments of the present disclosure an ion funnel includes a plurality of printed circuit boards that are interconnected to define an internal chamber. Each of the plurality of printed circuit boards includes a body and a plurality of electrodes. The body of each printed circuit board extends from a first end having a first dimension to a second end having a second dimension that is smaller than the first dimension. The plurality of electrodes are spaced along a length of the body between the first end and the second end. The internal chamber has an outer dimension that reduces at a convergence angle with respect to a central axis of the ion funnel. The convergence angle is less than 30 degrees for at least a majority of a length of the internal chamber, and at least a portion of the plurality of electrodes receive a radio frequency voltage that is configured to confine ions received by the ion funnel within the printed circuit boards.

In some aspects, the internal chamber can have a square cross-section.

In some other aspects, at least a portion of the plurality of electrodes can receive a direct current voltage that is configured to urge the ions toward the second ends of the bodies.

In other aspects, each of the PCBs can include a plurality of spaces configured to permit gas to be extracted from the ion funnel.

In still other aspects, the ion funnel can include a conductance limit that includes an orifice. The conductance limit can be interconnected with the plurality of printed circuit boards adjacent the second end of each body and can separate the ion funnel from a downstream device having a pressure greater than a pressure of the ion funnel, which causes gas from the downstream device to enter the ion funnel. In such aspects, the ion funnel can be configured to generate an electric field that urges the ions through the orifice of the conductance limit and causes the ions to enter the downstream device, which can be an ion mobility device.

In other aspects, each of the plurality of printed circuit boards can include a plurality of tabs and a plurality of notches for interconnecting the plurality of printed circuit boards.

In accordance with embodiments of the present disclosure an ion funnel system includes a first ion funnel and a second ion funnel. The first ion funnel includes a first entrance electrode, a first last electrode, and a first plurality of intermediate electrodes positioned between the first entrance electrode and the first last electrode. The first entrance electrode defines a first opening having a first inner dimension, and the first last electrode defines a second opening having a second inner dimension that is smaller than the first inner dimension. Each of the first plurality of intermediate electrodes define an associated first opening having an associated first inner dimension. The associated first inner dimensions progressively reduce in size from approximately the first inner dimension to approximately the second inner dimension. The first ion funnel also includes a first internal chamber that is defined by the first opening, the associated first openings of the first plurality of intermediate electrodes, and the second opening. The first internal chamber has an outer dimension that reduces at a first convergence angle from the first inner dimension to the second inner dimension, with the first convergence angle being less than 30 degrees for at least a majority of a length of the first internal chamber. The second ion funnel includes a second entrance electrode, a second last electrode, and a second plurality of intermediate electrodes positioned between the second entrance electrode and the second last electrode. The second entrance electrode defines a third opening having a third inner dimension, and the second last electrode defines a fourth opening having a fourth inner dimension that is smaller than the third inner dimension. Each of the second plurality of intermediate electrodes defines an associated second opening having an associated second inner dimension. The associated second inner dimensions progressively reducing in size from approximately the third inner dimension to approximately the fourth inner dimension. The second ion funnel also includes a second internal chamber defined by the third opening, the associated second openings of the second plurality of intermediate electrodes, and the fourth opening. The second internal chamber has an outer dimension that reduces at a first convergence angle from the third inner dimension to the fourth inner dimension, where the second convergence angle is less than 30 degrees for at least a majority of a length of the second internal chamber. At least a portion of the first plurality of intermediate electrodes receive a first radio frequency (RF) voltage configured to confine ions received by the first ion funnel, and at least a portion of the second plurality of intermediate electrodes receive a second RF voltage configured to confine ions received by the second ion funnel.

In accordance with embodiments of the present disclosure an ion funnel system includes a first ion funnel and a second ion funnel. The first ion funnel includes a first entrance electrode, a first last electrode, and a first plurality of intermediate electrodes positioned between the first entrance electrode and the first last electrode. The first entrance electrode defines a first opening having a first inner dimension and the first last electrode defines a second opening having a second inner dimension that is smaller than the first inner dimension. Each of the first plurality of intermediate electrodes defines a first associated opening having a first associated inner dimension, which progressively reduce in size from approximately the first inner dimension to approximately the second inner dimension. The second ion funnel includes a second entrance electrode, a second last electrode, and a second plurality of intermediate electrodes. The second entrance electrode defines a third opening having a third inner dimension and the second last electrode defines a fourth opening having a fourth inner dimension that is smaller than the third inner dimension. Each of the second plurality of intermediate electrodes define a second associated opening having a second associated inner dimension, which progressively reduce in size from approximately the third inner dimension to approximately the fourth inner dimension. Each of the first intermediate electrodes defines a first slope parameter with respect to an adjacent first intermediate electrode and each of the second intermediate electrodes defines a second slope parameter with respect to an adjacent second intermediate electrode, such that the first slope parameter of at least a majority of the first intermediate electrodes with respect to the respective adjacent first intermediate electrode is less than 0.27 and the second slope parameter of at least a majority of the second intermediate electrodes with respect to the respective adjacent second intermediate electrode is less than 0.27. Additionally, at least a portion of the first plurality of intermediate electrodes receive a first radio frequency (RF) voltage that is configured to confine ions received by the first ion funnel, and at least a portion of the second plurality of intermediate electrodes receive a second RF voltage that is configured to confine ions received by the second ion funnel.

In accordance with embodiments of the present disclosure an ion funnel includes an entrance electrode, a last electrode, a plurality of intermediate electrodes positioned between the entrance electrode and the last electrode, and an internal chamber. The internal chamber has an outer dimension and a length, with the outer dimension reducing at a convergence angle along the length. The convergence angle is less than 30 degrees for at least a majority of the length of the internal chamber. At least a portion of the plurality of intermediate electrodes receive a radio frequency (RF) voltage that is configured to confine ions received by the ion funnel.

In some aspects, the entrance electrode, the last electrode, and the plurality of intermediate electrodes can be ring electrodes or plate electrodes. In such aspects, the internal chamber can be defined by the entrance electrode, the last electrode, and the intermediate electrodes.

In other aspects, the entrance electrode, the last electrode, and the plurality of intermediate electrodes can be formed on one or more printed circuit boards. In such aspects, the internal chamber can be defined by the one or more printed circuit boards.

Other features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

The foregoing features of the present disclosure will be apparent from the following Detailed Description of the Invention, taken in connection with the accompanying drawings, in which:

FIG. 1 is a partial sectional view of an ion funnel system having two ion funnels and the results of a pressure simulation therefor;

FIG. 2 is a schematic diagram of an exemplary ion mobility separation system of the present disclosure;

FIG. 3 is a partial perspective sectional view of an ion funnel, capillary, and ion mobility separation device of the present disclosure;

FIG. 4 shows the results of a first pressure simulation for the ion funnel of the present disclosure;

FIGS. 5A and 5B show the results of a first gas flow velocity simulation for the ion funnel of the present disclosure;

FIG. 6 shows the results of a second pressure simulation for the ion funnel of the present disclosure as a pressure gradient;

FIG. 7 shows the results of a third pressure simulation for the ion funnel of the present disclosure as a pressure gradient;

FIGS. 8A and 8B show the partial results of a second gas flow velocity simulation for the ion funnel of the present disclosure with a focus at an interface of the ion funnel with a conductance limit;

FIGS. 9A and 9B show the partial results of a third gas flow velocity simulation for the ion funnel of the present disclosure with a focus at an interface of the ion funnel with the conductance limit;

FIGS. 10A and 10B show the partial results of a fourth gas flow velocity simulation for the ion funnel of the present disclosure with a focus at an interface of the ion funnel with the conductance limit;

FIG. 10C is a chart of ion mass (m/e) versus percentage of 1000 ions transmitted for the fourth gas flow velocity simulation;

FIGS. 11A and 11B show the partial results of a fifth gas flow velocity simulation for the ion funnel of the present disclosure with a focus at an interface of the ion funnel with the conductance limit;

FIG. 11C is a chart of ion mass (m/e) versus percentage of 1000 ions transmitted for the fifth gas flow velocity simulation;

FIGS. 12A and 12B show the partial results of sixth gas flow velocity simulation for the ion funnel of the present disclosure with a focus at an interface of the ion funnel with the conductance limit;

FIG. 12C is a chart of ion mass (m/e) versus percentage of 1000 ions transmitted for the sixth gas flow velocity simulation;

FIGS. 13A and 13B show the partial results of seventh gas flow velocity simulation for the ion funnel of the present disclosure with a focus at an interface of the ion funnel with the conductance limit;

FIG. 13C is a chart of ion mass (m/e) versus percentage of 1000 ions transmitted for the seventh gas flow velocity simulation;

FIG. 14 is an enlarged view of Area A-A of FIG. 3 showing details of the ion funnel, the conductance limit, and the ion mobility separation device of the present disclosure;

FIG. 15 is a top rear perspective view of an alternative ion funnel;

FIG. 16 is bottom plan view of the alternative ion funnel of FIG. 15;

FIG. 17 is side elevational view of the alternative ion funnel of FIG. 15;

FIG. 18 is a sectional view of the alternative ion funnel taken along line 18-18 of FIG. 16;

FIG. 19 is a front perspective view of another ion funnel of the present disclosure;

FIG. 20 is a rear perspective view of the ion funnel of FIG. 19;

FIG. 21 is a side elevational view of the ion funnel of FIG. 19;

FIG. 22 is a front elevational view of the ion funnel of FIG. 19;

FIG. 23 is a top plan view of a printed circuit board of the ion funnel of FIG. 19;

FIG. 24 is a bottom plan view of the printed circuit board of FIG. 23;

FIG. 25 is a detailed view of Area 25-25 of FIG. 24;

FIG. 26 is a sectional view of two ion funnels of the present disclosure arranged in series;

and

FIG. 27 is a diagram illustrating hardware and software components capable of being utilized to implement embodiments of the system of the present disclosure.

### DETAILED DESCRIPTION

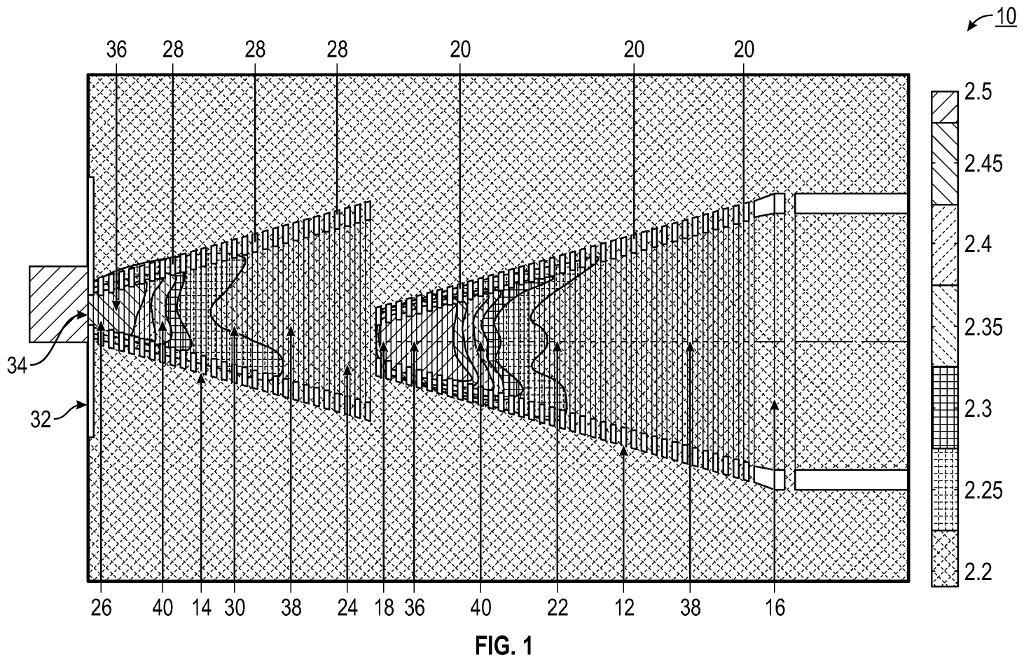

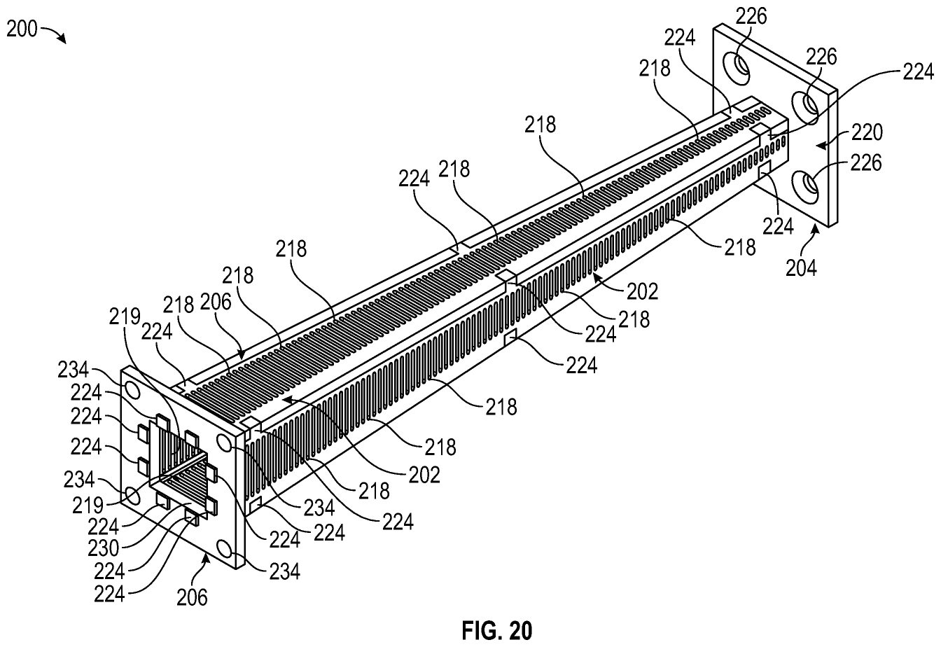

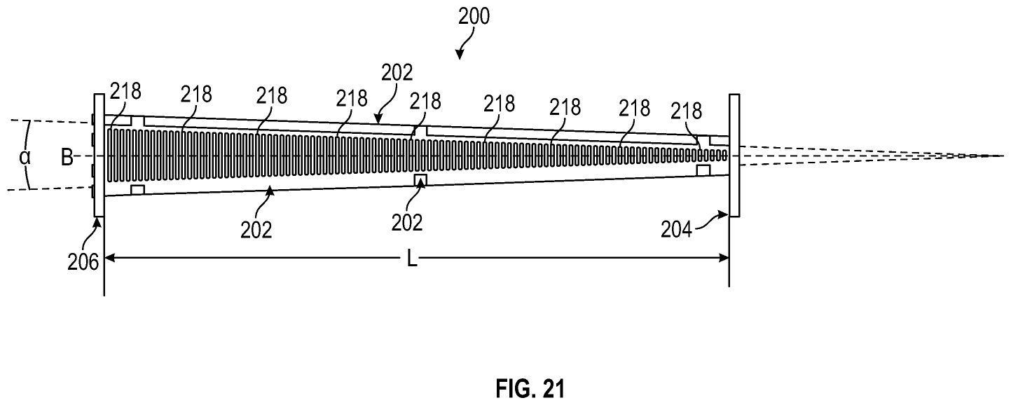

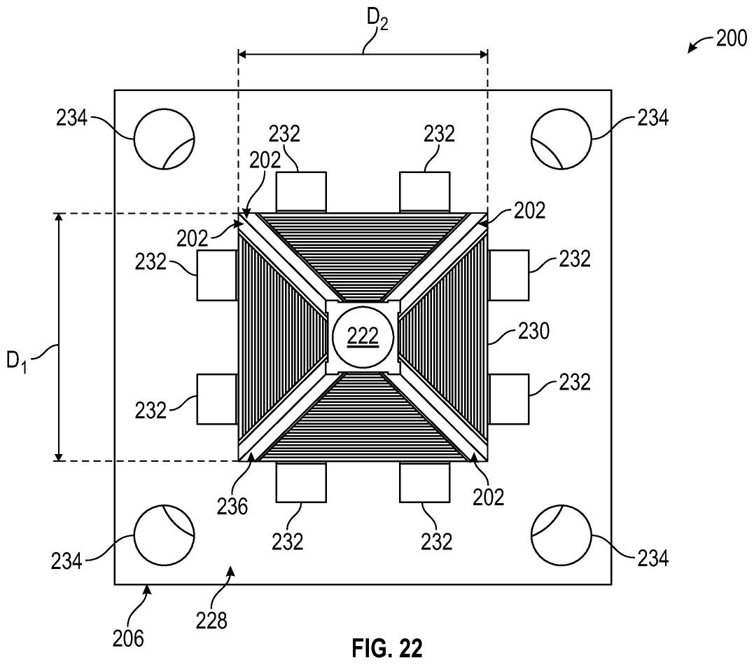

The present disclosure relates to ion funnels having improved pressure distribution and flow characteristics, as described in detail below in connection with FIGS. 1-27.

FIG. 1 is a partial sectional view of an ion funnel system 10 including first and second ion funnels 12, 14 that are aligned in series with the first ion funnel 12 discharging into the second ion funnel 14. The first ion funnel 12 includes an entrance region 16, an exit region 18, and a series of electrodes 20, e.g., stacked ring electrodes, that extend from the entrance region 16 to the exit region 18 and define an interior chamber 22. The entrance region 16 can receive a capillary (not shown), e.g., from an ion source such as an electrospray ionizer, that discharges ions into the interior chamber 22. The electrodes 20 are spaced apart from each other, which allows for gas to exit the interior chamber 22.

The second ion funnel 14 is similar in construction to the first ion funnel 12 and includes an entrance region 24, an exit region 26, and a series of electrodes 28 that extend from the entrance region 24 to the exit region 26 and define an interior chamber 30. The exit region 18 of the first ion funnel 12 is positioned adjacent the entrance region 24 of the second ion funnel 14 so as to discharge ions into the second ion funnel 14. The electrodes 28 are spaced apart from each other, which allows for gas to exit from the interior chamber 30. A conductance limit orifice plate 32 is positioned adjacent the exit region 26 and last ring electrode of the second ion funnel 14. The conductance limit orifice plate 32 includes a central orifice 34 through which ions exit the second ion funnel 14 and enter an ion manipulation device. A conductance limit orifice plate 32 can also be positioned adjacent the exit region 18 of the first ion funnel 12 to largely mitigate turbulence and local high pressure in the second ion funnel 14.

FIG. 1 also illustrates the results of a pressure simulation of the ion funnel system 10. As can be seen from the pressure simulation of FIG. 1, the pressure distribution is sudden and sharp, e.g., compressed, with the majority of the respective interior chambers 22, 30 of first and second ion funnels 12, 14 either having a high pressure 36, e.g., greater than 2.45 Torr, or a low pressure 38, e.g., less than 2.25 Torr, and a smaller region having an intermediate pressure 40, e.g., between 2.3 Torr and 2.4 Torr. This compressed pressure distribution can result in increased turbulence, and impact the removal of gas from the ion funnels 12, 14 and the separation of the ions from the gas. However, as previously noted, incorporating a conductance limit orifice plate 32 at the end of the first ion funnel 12 can largely mitigate the potential turbulence and local high pressure regions within the second ion funnel 14.

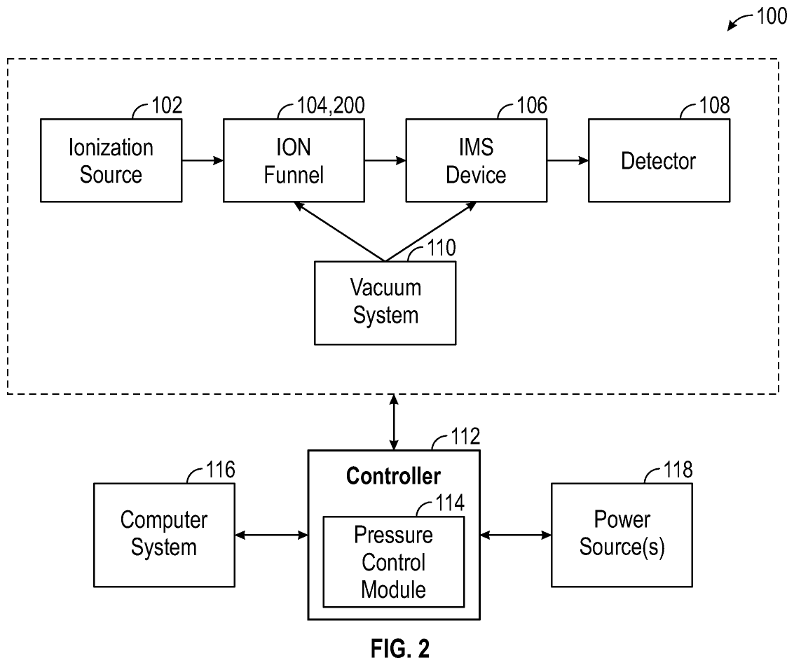

FIG. 2 is a schematic diagram of an exemplary ion mobility separation (IMS) system 100 in accordance with the present disclosure. The IMS system 100 includes an ionization source 102, an ion funnel 104, an ion mobility separation (IMS) device 106, a detector 108 (e.g., a mass spectrometer such as a time of flight (TOF) mass spectrometer), a vacuum system 110, a controller 112, a computer system 116, and one or more power sources 118.

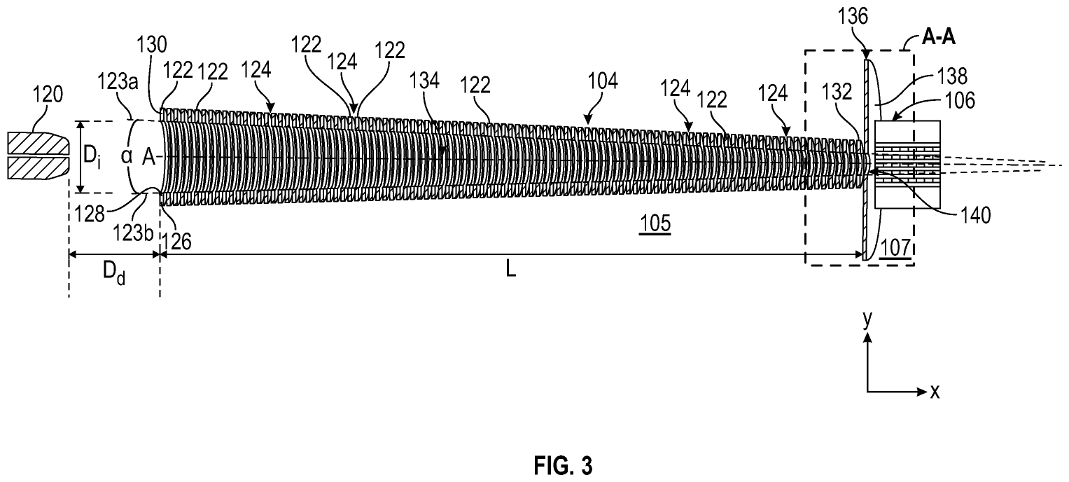

The ionization source 102 generates ions (e.g., ions having varying mobility and mass-to-charge-ratios) and injects the ions into the ion funnel 104 through a capillary 120 (see FIG. 3). For example, the ionization source 102 can be an electrospray ionizer and the capillary 120 can be any capillary generally known in the art, such as a heated capillary, which can be conductive, resistive, or insulating, for example. The ions exiting the capillary 120 are entrained in a gas flow that controls movement of the ions as they enter the ion funnel 104. The ion funnel 104 is an ion funnel that is configured to transmit ions to the ion separation device 104, and is described in more detail in connection with FIG. 3. The ion funnel 104 is positioned within a vacuum chamber 105 that is in fluidic communication with the vacuum system 110 which controls/regulates the pressure within the vacuum chamber 105 and removes gas from the ion funnel 104 and the vacuum chamber 105. In this regard, the ion funnel vacuum system 100 can include a vacuum pump and a pressure gauge/sensor(s). The pressure gauge/sensor(s) can be positioned in communication with the vacuum chamber 105 to provide a reading of the vacuum chamber pressure, while the vacuum pump can regulate the pressure within the vacuum chamber 105 in response to the pressure gauge/sensor(s) reading. This can be achieved by adjusting/throttling the speed of the pump or by metering in a back-fill gas into the vacuum chamber 105.

The ion mobility separation device 106 can be configured to separate the ions based on their mobility via ion mobility spectrometry (IMS). Mobility separation can be achieved, for example, by applying one or more potential waveforms (e.g., traveling potential waveforms, direct current (DC) gradient, or both) on the ions. In this regard, the ion mobility separation device 106 can be a structure for lossless ion manipulation (SLIM) that performs IMS based mobility separation by systematically applying a traveling potential waveform to a collection of ions. For example, the ion mobility separation device 106 can be configured and operated in accordance with the SLIM devices disclosed and described in U.S. Pat. No. 8,835,839 entitled “Method and Apparatus for Ion Mobility Separations Utilizing Alternating Current Waveforms” and U.S. Pat. No. 10,317,364 entitled “Ion Manipulation Device,” both of which are incorporated herein by reference in their entirety. Moreover, the ion mobility separation device 106 can be configured to transfer ions, accumulate ions, store ions, and/or separate ions, depending on the desired functionality and waveforms applied thereto by the controller 112. However, it should be understood that the ion mobility separation device 106 need not be a SLIM device, but can be any device that separates ions based on mobility.

The ion mobility separation device 106 can be positioned in a respective vacuum chamber 107 that can be in fluidic communication with the vacuum system 110. In this regard, the vacuum system 110 can control/regulate the gas pressure within the vacuum chamber 107 in which the ion mobility separation device 106 is positioned and thus within the ion mobility separation device 106 itself. Specifically, the vacuum system 110 can provide nitrogen to the ion mobility separation device vacuum chamber 107 while maintaining the pressure therein at a consistent level, or adjust/throttle the speed of the pump in communication with the vacuum chamber 107 in which the ion mobility separation device 106 is positioned. It should be understood that separate vacuum systems can be provided for each of the chambers 105, 107 in which the ion funnel 104 and the ion mobility separation device 106 are positioned if so desired.

The controller 112 can receive power from one of the power sources 118, which can be, for example, a DC power source that provides DC voltage to the controller 112, and can be in communication with and control operation of the ionization source 102, the ion funnel 104, the ion mobility separation device 106, the detector 108, and the vacuum system 110. For example, the controller 112 can control the rate of injection of ions into the ion funnel 104 by the ionization source 102, the target mobility of the ion mobility separation device 106, the pressure within the ion funnel 104 (e.g., through control of the vacuum system 110), the pressure within the IMS device 106 (e.g., through control of the vacuum system 110), and ion detection by the detector 108. In some aspects, e.g., when the ion mobility separation device 106 is a SLIM device, the controller 112 can control the characteristics and motion of potential waveforms (e.g., amplitude, shape, frequency, etc.) generated by the ion mobility separation device 106 (e.g., by applying RF/AC/DC potentials to the electrodes of the ion separation device 106) in order to transfer, accumulate, store, and/or separate ions.

The controller 112 can be communicatively coupled to a computer system 116. For example, the computer system 116 can provide operating parameters of the IMS system 100 via a control signal to the master control circuit. In some implementations, a user can provide the computer system 116 (e.g., via a user interface) with the operating parameters. Based on the operating parameters received via the control signal, the master control circuit can control the operation of the RF/AC/DC control circuits which in turn can determine the operation of the coupled IMS device 106. In some implementations, RF/AC/DC control circuits can be physically distributed over the IMS system 100. For example, one or more of the RF/AC/DC control circuits can be located in the IMS system 100, and the various RF/AC/DC control circuits can operate based on power from the power sources 118.

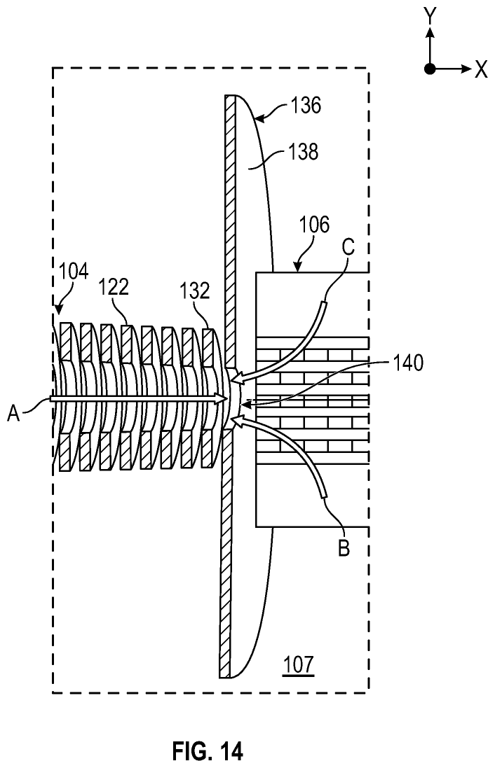

The controller 112 can also include a dedicated pressure control module 114 that controls the operation of the vacuum system 110. In particular, the pressure control module 114 can control the vacuum pumps, e.g., the speed, as well as the amount of gas being backfilled into the vacuum chambers 105, 107 of the ion funnel 104 and IMS device 106. For example, the pressure control module 114 can control the vacuum system 110, and the components associated therewith, to achieve a counter-flow pressure gradient from the IMS device 106 into the ion funnel 104, as discussed in greater detail in connection with FIGS. 3 and 14. The pressure control module 114 can be responsive to changes in various characteristics of the components of the IMS system 100 to achieve a desired pressure condition. For example, the pressure control module 114 can automatically adjust the speed of the vacuum pumps, the pressure within the vacuum chambers 105, 107, the amount of gas being backfilled into the vacuum chambers 105, 107, etc., based on changes to the sample being introduced into the IMS system 100, e.g., a change in the composition thereof, and/or changes to the capillary 120, e.g., increase/decrease in capillary temperature or discharge flow rate. The vacuum system 110 can also include a manual valve in place of or in addition to the pressure control module 114 that allows a user to manually adjust the pressure within the vacuum chambers 105, 107 or the gas input, e.g., backfill into the vacuum chambers 105, 107.

FIG. 3 is a partial perspective sectional view of the ion funnel 104, capillary 120, and ion mobility separation device 106 of the present disclosure. The capillary 120 is positioned adjacent or within the ion funnel 104. The capillary 120 is connected with, and receives ions from, the ionization source 102. The capillary 120 discharges the ions received from the ionization source 102 into the ion funnel 104.

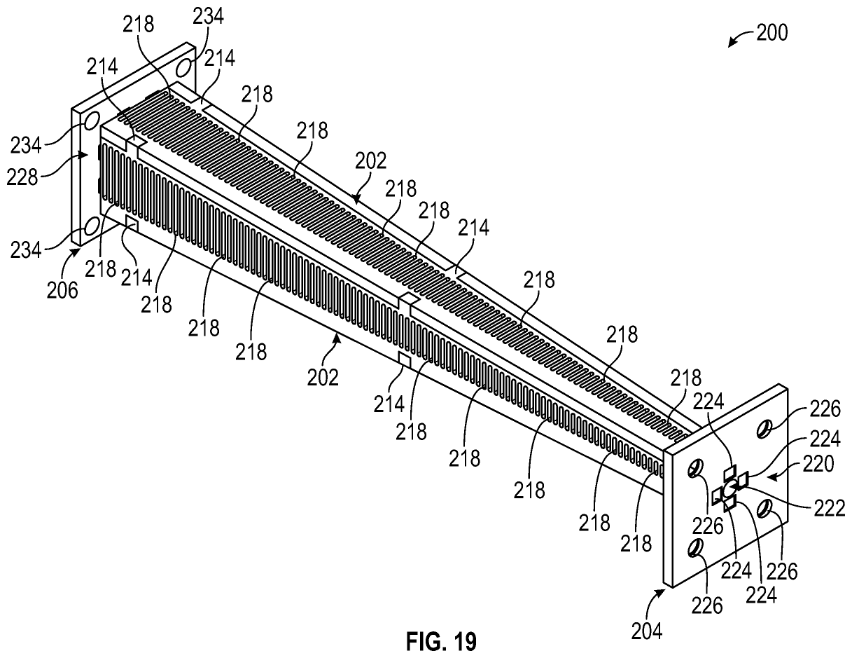

The ion funnel 104 can be, for example, a stacked ring electrode ion funnel that includes a series of electrodes 122 that are positioned adjacent to one another with a gap 124 between adjacent electrodes 122. The electrodes 122 can be, for example, stacked ring electrodes, plate electrodes, or electrodes formed on one or more printed circuit boards. However, it should be understood that the present disclosure contemplates other ions funnels, such as those made of printed circuit boards. In the case of a stacked ring ion funnel, which is shown in the exemplary embodiment of FIG. 3, each of the stacked ring electrodes 122 includes a ring-shaped body 126 having a central opening 128. The series of electrodes 122 extends from an entrance electrode 130 to a last electrode 132, with a plurality intermediate electrodes 122 between the entrance electrode 130 and the last electrode. Each of the central openings 128 can have an associated center point and the center points of the electrodes 122 can be in substantially a straight line. For example, the electrodes 122 can be substantially coaxial. The inner dimension, e.g., diameter Dᵢ, of the central opening 128 of the electrodes 122 decreases from the entrance electrode 130 to the last electrode 126 and forms an internal chamber 134. For example, the diameter Dᵢ of the central opening 128 of the entrance electrode 130 can be 10 mm and the diameter Dᵢ of the central opening 128 of the last electrode 132 can be 3 mm. It should be understood that the present disclosure also contemplates a central opening 128 that is not circular. For example, the central opening 128 could be oval, square, rectangular, etc. In such instances, the inner dimension could be the height and/or width of the central opening 128 thereof. Moreover, the central opening 128 need not be formed in or by the electrode itself, but instead can be formed by a structure on which the electrode(s) is formed, disposed, mounted, etc. For example, the electrodes 122 could be formed on printed circuit boards (PCBs) that are connected in a truncated pyramidal configuration, such as that shown and described in connection with FIGS. 19-22. In this configuration, the inner dimension could be the space between opposing PCBs, e.g., the height and/or width of the central opening defined thereby.

RF and DC electrical signals are co-applied to the electrodes 122 to maintain the ions within the ion funnel 104 and to transport the ions toward a conductance limit orifice plate 136. Specifically, RF and DC electrical signals are co-applied to the electrodes 122 to create a pseudopotential that repels the ions from the electrodes 122. In this regard, alternating RF polarities are applied to adjacent electrodes 122 (e.g., an RF+ electrical signal is applied to a first electrode and an RF− electrical signal is applied to a second adjacent electrode) that repel the ions from the electrodes 122. Additionally, a DC gradient is applied to all of the electrodes 122 whereby the entrance electrode 130 has the greatest magnitude DC voltage bias (e.g., repulsive to the ions so that they are pushed further into the ion funnel 104) and the last electrode 132 has the lowest magnitude DC voltage bias relative to the other electrodes 122. The DC gradient pushes the ions toward the conductance limit 136, which is a plate 138 having an orifice 140 in the middle that separates the ion funnel 104 from the ion mobility separation device 106. The ions are transmitted through the orifice 140 and into the ion mobility separation device 106. In this regard, the conductance limit 136 and corresponding orifice 140 separate adjacent chambers, e.g., the chamber in which the ion funnel 104 is positioned and the chamber in which the IMS device 106 is positioned, in order to maintain the different pressures and/or gases within each respective chamber by reducing the gas flow from one chamber into the other. It is additionally noted that the polarity of the DC gradient applied to the electrodes 122 can be keyed to specific samples based on the polarity of the ions within the sample to ensure that the DC gradient sufficiently propels the ions through the ion funnel 104.

In operation, the capillary 120 discharges ions entrained in a gas through the central opening 128 of the entrance electrode 130 and into the internal chamber 134. In this regard, the inner diameter Dᵢ of the central opening 128 of the entrance electrode 130 should be sufficiently large enough to completely contain the emergent gas jet discharged from the capillary 120. For example, the size of the central opening inner diameter Dᵢ of the entrance electrode 130 can be based on a consideration of the capillary 120 discharge flow rate, the pressure within the ion funnel chamber, the distance Dᵢ from the discharge of the capillary 120 to the entrance electrode 130, the presence/absence of the ion funnel electrodes 122, etc., all of which could potentially impact the size and/or shape of the gas jet discharged from the capillary 120. A DC voltage can be applied to the capillary 120 having a magnitude greater than the DC voltage applied to the entrance electrode 130 such that the ions discharged from the capillary 120 are attracted to the entrance electrode 130 and into the internal chamber 134. That is, the DC voltage profile should be configured to propel ions further into the ion funnel. The RF electrical signals applied to the electrodes 122 create a potential barrier adjacent the interior surface of the electrodes 122 that pushes the ions away from the electrodes 122, while the DC voltage signals transport the ions toward and through the conductance limit 136. The ions gradually move toward the center of the internal chamber 134 as they traverse the internal chamber 134 and pass through the central openings 128 of the electrodes 122 that sequentially reduce in inner diameter Dᵢ. The gaps 124 between the electrodes 122 allow the gas to escape and be removed from the ion funnel 104 while the ions are retained within the internal chamber 134. Thus, the gas and the ions are separated such that only the ions are transferred into the ion mobility separation device 106.

As previously noted, the central openings 128 of the electrodes 122 reduce sequentially in inner dimension Dᵢ from the entrance electrode 130 to the last electrode 132, which can be, for example, a linear or non-linear reduction. Accordingly, the internal chamber 134 can be characterized as having a taper angle or convergence angle α defined by the central openings 128 of the electrodes 122. That is, the convergence angle α can be understood to be the angle αt which the central openings 128 of adjacent electrodes 122 converge toward each other. For example, if one were to draw a first line 123a extending between the central openings 128 of adjacent electrodes 122 and a second line 123b directly opposite (e.g., diametrically opposite) the first line 123a, the convergence angle α would be the angle formed between these two lines 123a, 123b. Alternatively, these two lines can be drawn as extending between the central opening 128 of the entrance electrode 130 to the central opening 128 of the last electrode 132. The convergence angle α of the ion funnel 104 of the present disclosure is equal to or less than approximately 30° for a majority of the length of the internal chamber 134, and in some instances less than 20°. Alternatively, the internal chamber 134 can be characterized by the slope thereof. For example, for coaxial electrodes 122, the funnel shape of the internal chamber 134 formed by the reduction in inner dimension Dᵢ can have a slope parameter that can be calculated as half of the change in central opening 128 inner dimension Dᵢ between adjacent electrodes over the distance of the space 124 there between, e.g., between the adjacent electrodes, or as half of the change in central opening 128 inner dimension Dᵢ between the entrance electrode 130 and the last electrode 132 divided by the distance L between the entrance electrode 130 and the last electrode 132. The slope parameter of each side of the internal chamber 134 of the ion funnel 104 of the present disclosure can be equal to or less than approximately 0.27, or in some instances equal to or less than approximately 0.18.

The above-described slope and convergence angle α of the ion funnel 104 of the present disclosure is less than that of prior art funnels, and causes more drag on the gas flow within the internal chamber 134 and reduces the diameter of the gas flow slip stream within the internal chamber 134 compared to prior art ion funnels. This results in a more even pressure distribution within the internal chamber 134, such that the pressure gradient is smoother and extends along the full length L of ion funnel 104, which results in more gas being extracted along the full length thereof, as opposed to gas extraction occurring primarily at the end of ion funnel 104 (e.g., adjacent the conductance limit 136) as in prior art ion funnels. This allows for improved gas flow control within the ion funnel 104 which can be implemented to prevent the gas within the ion funnel 104 from entering the IMS device 106 through the conductance limit 136 and enable the counter-flow of gas from the IMS device 106 into the ion funnel 104, e.g., an inversion of the typical gas flow through the conductance limit 136, such that a net gas flow enters the ion funnel 104 through the entrance and last electrodes 130, 132 and is evacuated laterally between the electrodes 122. This functionality ensures that the purity of the gas composition downstream of the ion funnel 104, e.g., within the IMS device chamber, is maintained, prevents gas flow within the ion funnel 104 from potentially impacting the manipulation, e.g., trapping and transmission, of ions within the downstream IMS device 106, and allows for high-pass ion mobility filtering to be performed, as discussed in greater detail in connection with FIG. 14. In this regard, the IMS device 106 can be maintained at a first pressure, e.g., 2.5 Torr, by the vacuum system 110 and pressure control module 114, and the ion funnel 104 can be maintained at a second pressure, e.g., 2.2 Torr, that is less than the first pressure, for example, by the vacuum system 110 and pressure control module 114. Since the first pressure of the IMS device 106 can be greater than the second pressure of the ion funnel 104, the gas within the ion funnel 104 is generally prevented from entering the IMS device 106, e.g., through the conductance limit 136. However, this pressure differential can be overcome if an ion funnel does not sufficiently extract the gas discharged from the capillary and allows a pressure build up at the end of the ion funnel adjacent the conductance limit. In such instances, gas from the ion funnel can flow into the IMS device and contaminate the IMS device. Nonetheless, the ion funnel 104 of the present disclosure overcomes this potential issue by extracting gas along the full length thereof and preventing pressure buildup adjacent the conductance limit 136, thus enabling the counter-flow of gas from the IMS device 106 into the ion funnel 104 and permitting operation over a greater range of pressure conditions.

Moreover, the ion funnel 104 of the present disclosure results in a reduction in turbulence therein, e.g., adjacent the exit of the ion funnel 104, which in turn results in a less time-dependent fluctuation of the ion signal detected by the detector 108. This is particularly useful when the ion funnel 104 of the present disclosure is combined with an IMS device 106 that accumulates ions prior to performing ion mobility separation. More specifically, such an IMS device 106 may accumulate ions for a period spanning a few milliseconds, and it is likely that turbulence within an ion funnel (e.g., of the prior art) will result in the IMS device 106 collecting different amounts of ions during sequential accumulation periods simply due to variable transmission through the conductance limit. However, the ion funnel 104 of the present disclosure significantly mitigates such turbulence and ion transmission fluctuations, thus allowing the IMS device 106 to collect a more uniform number of ions during sequential accumulation periods, as well as a more robust and consistent transmission of ions from the ion funnel 104 across a broader range of inlet flow rates from the capillary 120.

The present disclosure additionally contemplates combining two or more ion funnels 104 sequentially, such as in the configuration illustrated in FIG. 1 and described in connection therewith. It is also contemplated that one of the foregoing ion funnels in the tandem ion funnel system can be a regular ion funnel. That is, the ion funnel 104 can be sequentially combined with a second regular ion funnel. In this contemplated configuration, the ion funnel 104 of the present disclosure can be provided first and discharge into the second regular ion funnel, or the regular ion funnel can be provided first and discharge into the ion funnel 104 of the present disclosure.

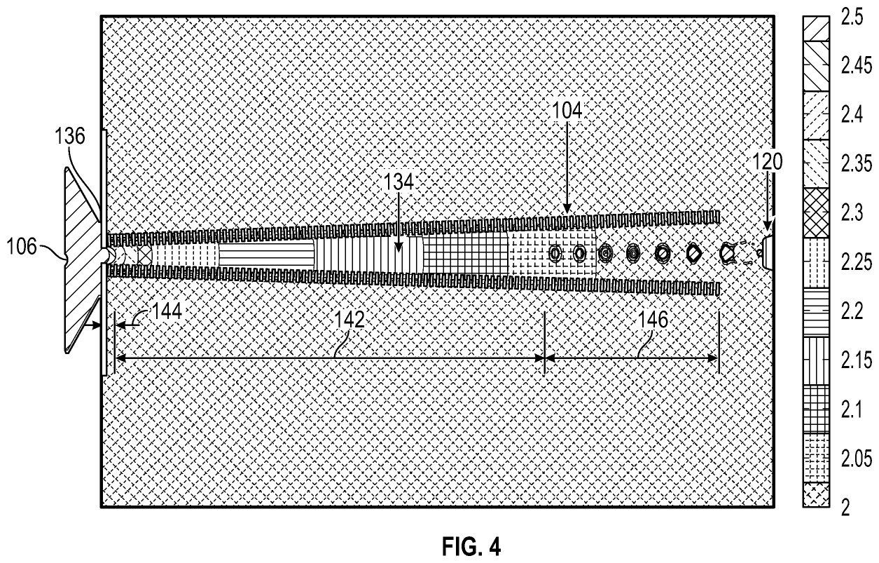

Various simulations were performed to analyze the ion funnel 104 of the present disclosure. These simulations were performed to determine pressure characteristics of the ion funnel 104, flow characteristics of the ion funnel 104, and ion transmission rate of the ion funnel 104. These simulations are discussed in connection with FIGS. 4-13B below, and further serve to illustrate the present disclosure and should not be interpreted or construed to limit the scope of the present disclosure.

FIG. 4 shows the results of a first pressure simulation for the ion funnel 104 of the present disclosure where the pressure within the ion mobility separation device 106 is 2.5 Torr, the pressure applied to the ion funnel chamber 134 by the vacuum system 110 is 2.2 Torr, and the temperature of the capillary is 150° C. As can be seen in FIG. 4, the pressure gradient extends along the full length of the ion funnel 104 with a large region 142 of the ion funnel chamber 134 having an intermediate pressure, e.g., between 2.1 Torr and 2.4 Torr. However, only a small region 144 has a high pressure, e.g., greater than 2.4 Torr, while another small region 146 has a low pressure, e.g., less than 2.1 Torr. This pressure distribution facilitates the removal of gas from the ion funnel chamber 134 of the ion funnel 104, as well as assisting with preventing gas from entering the ion mobility separation device 106 through the conductance limit 136 from the ion funnel chamber 134.

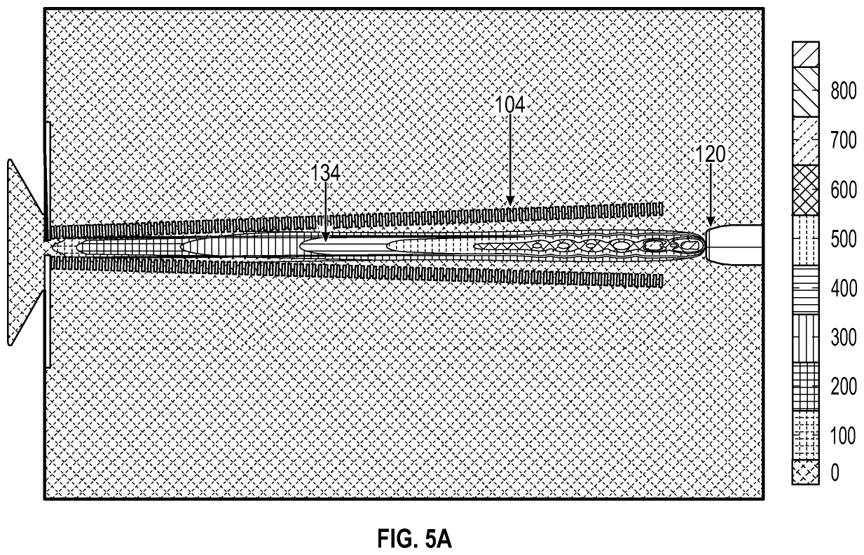

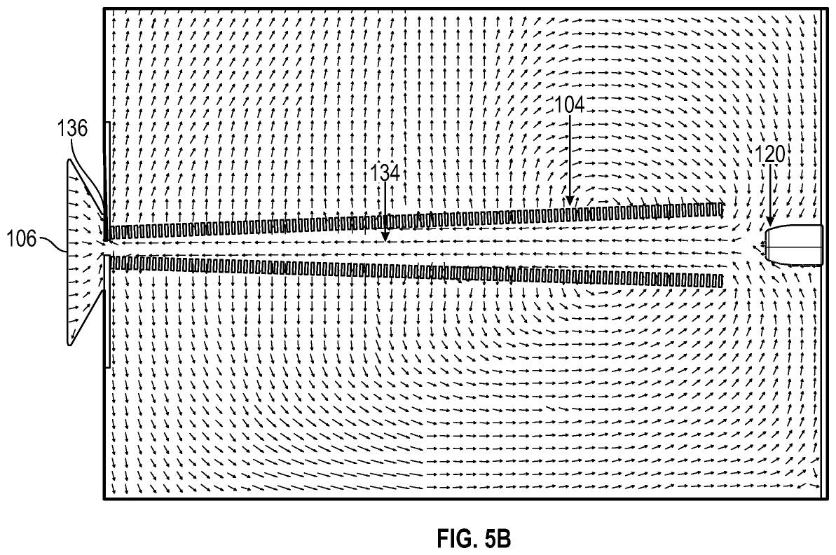

Additionally, FIGS. 5A and 5B shows the results of a first gas flow velocity simulation for the ion funnel 104 of the present disclosure where the pressure within the ion mobility separation device 106 is 2.5 Torr, the pressure applied to the ion funnel chamber 134, e.g., by the vacuum system 110, is 2.2 Torr, and the temperature of the capillary is 150° C. As can be seen in FIG. 5A, a velocity gradient extends along the full length of the ion funnel 104 with the gas velocity adjacent the conductance limit 136 being 0 m/s, which illustrates that gas is prevented from exiting the ion funnel chamber 134 through the conductance limit 136 and entering the ion mobility separation device 106. Additionally, as shown in FIG. 5B, the flow arrows illustrate that gas exits the ion funnel 104 for nearly the entire length thereof, which assists with ensuring that gas is not exiting the ion funnel chamber 134 through the conductance limit 136.

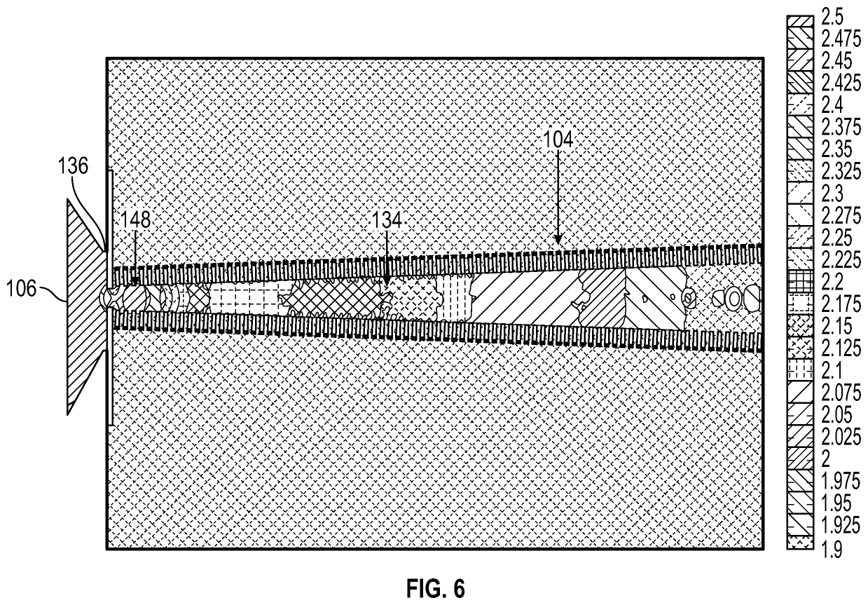

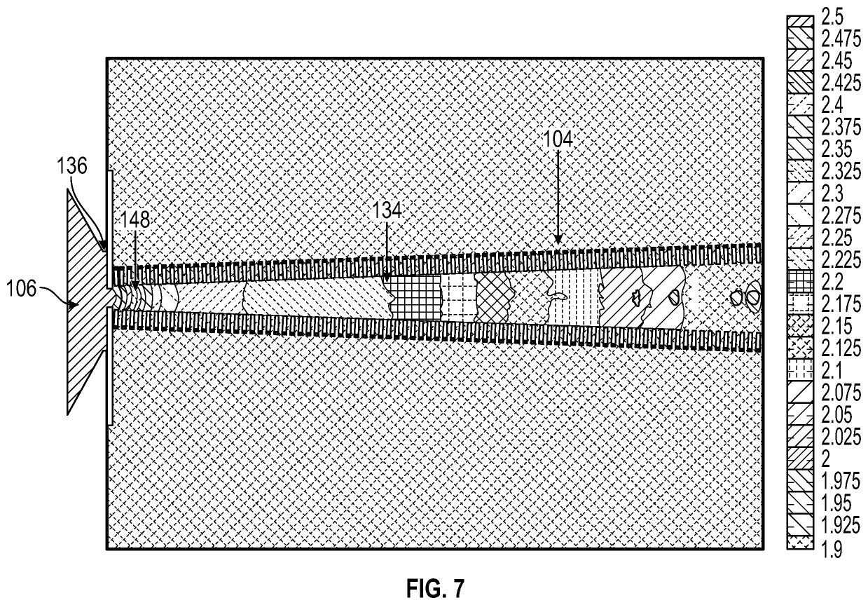

FIG. 6 shows the results of a second pressure simulation for the ion funnel 104 of the present disclosure where the pressure within the ion mobility separation device 106 is 2.50 Torr, the pressure applied to the ion funnel chamber 134 by the vacuum system 110 is 2.20 Torr, and the temperature of the capillary is 150° C., and FIG. 7 shows the results of a third pressure simulation for the ion funnel 104 of the present disclosure where the pressure within the ion mobility separation device 106 is 2.50 Torr, the pressure applied to the ion funnel chamber 134 by the vacuum system 110 is 2.19 Torr, and the temperature of the capillary is 150° C. The results of the second and third pressure simulations are shown as pressure gradients in FIGS. 6 and 7, respectively. As can be seen in FIGS. 6 and 7, when the pressure applied to the ion funnel chamber by the vacuum system 110 is reduced from 2.20 Torr to 2.19 Torr the high pressure region 148 extends further into the ion funnel chamber 134 ensuring that gas does not enter the ion mobility separation device 106 from the ion funnel chamber 134 through the conductance limit 136.

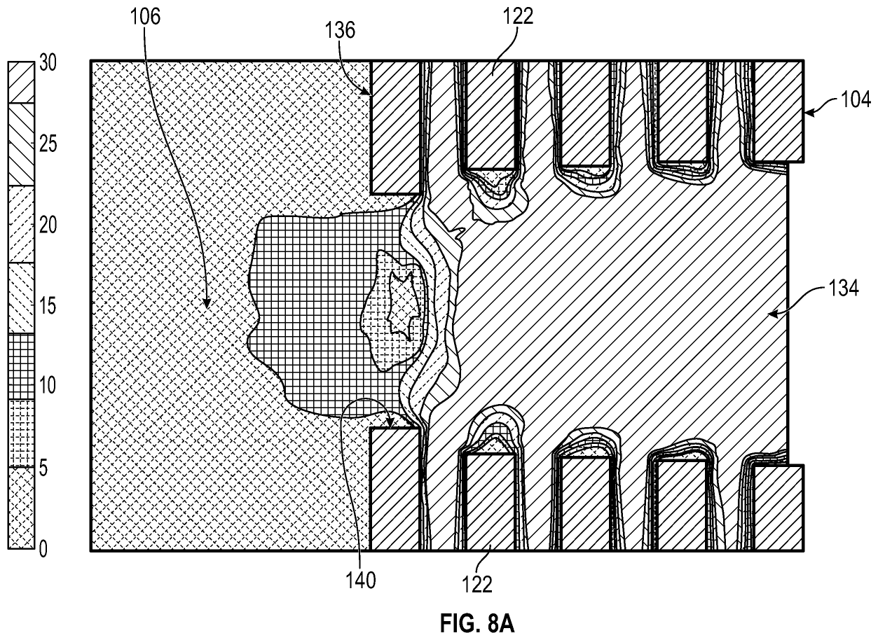

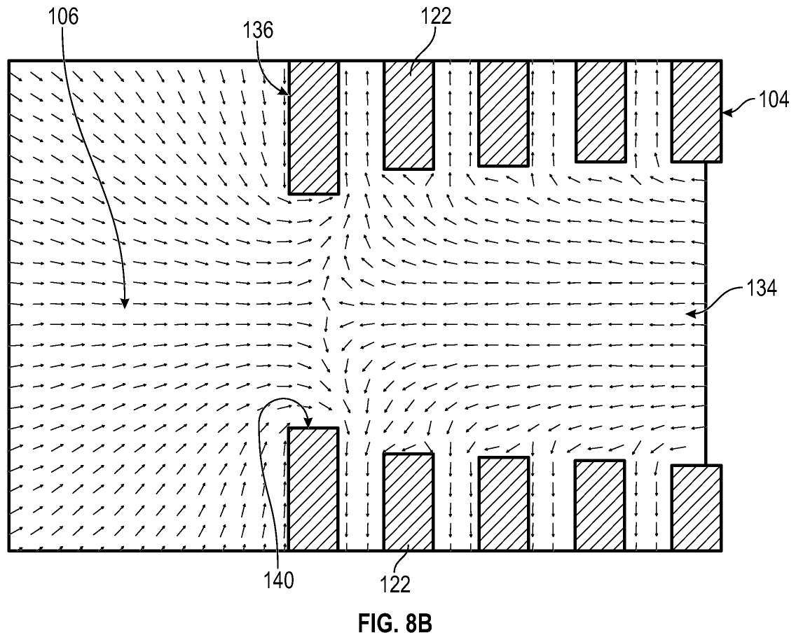

FIGS. 8A and 8B show the partial results of a second gas flow velocity simulation for the ion funnel 104 of the present disclosure with a focus at the interface of the ion funnel 104 with the conductance limit 136 where the pressure within the ion mobility separation device 106 is 2.50 Torr, the pressure applied to the ion funnel chamber 134 by the vacuum system 110 is 2.20 Torr, and the temperature of the capillary is 150° C. FIG. 8A illustrates a velocity gradient, while FIG. 8B includes flow arrows that indicate the direction of gas flow. As can be seen, the region of gas flow reversal is very narrow and located immediately before the conductance limit orifice 140 in the ion funnel chamber 134. Accordingly, the gas within the ion funnel chamber 134 approaches, but does not enter, the ion mobility separation device 106 through the orifice 140 of the conductance limit 136.

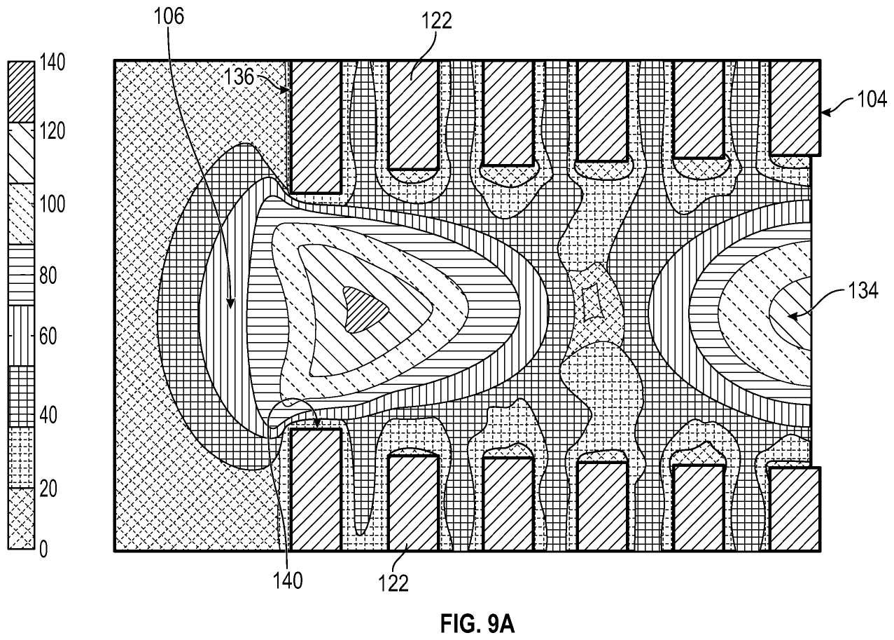

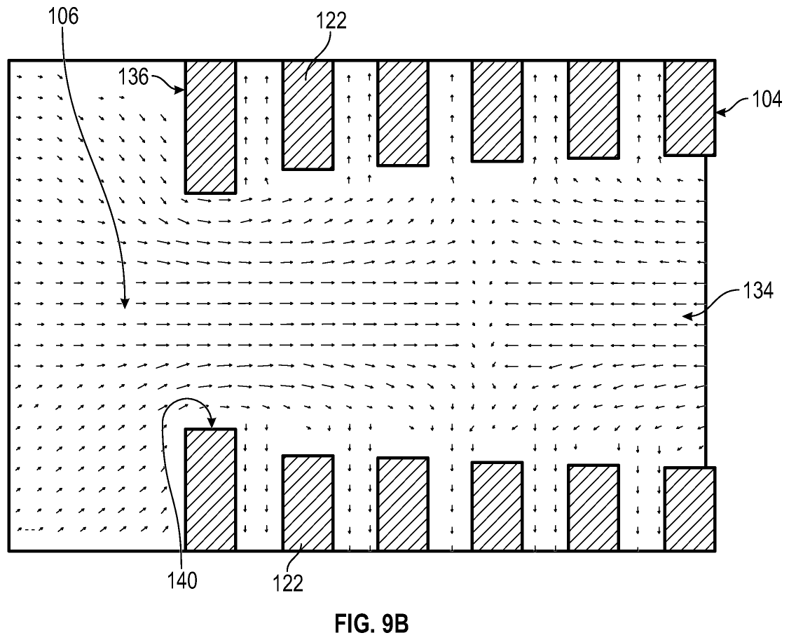

FIGS. 9A and 9B show the partial results of a third gas flow velocity simulation for the ion funnel 104 of the present disclosure with a focus at the conductance limit 136 where the pressure within the ion mobility separation device 106 is 2.50 Torr, the pressure applied to the ion funnel chamber 134 by the vacuum system 110 is 2.19 Torr, and the temperature of the capillary is 150° C. FIG. 9A illustrates a velocity gradient, while FIG. 9B includes flow arrows that indicate the direction of gas flow and are proportional in length to the velocity magnitude of the gas flow. As can be seen, the region of gas flow reversal is less narrow than in FIGS. 8A and 8B, and located further within the ion funnel chamber 134. Accordingly, the gas from the ion mobility separation device 106 extends into the ion funnel chamber 134 through the orifice 140 of the conductance limit 136 and prevents the gas within the ion funnel chamber 134 from entering the ion mobility separation device 106 through the orifice 140 of the conductance limit 136.

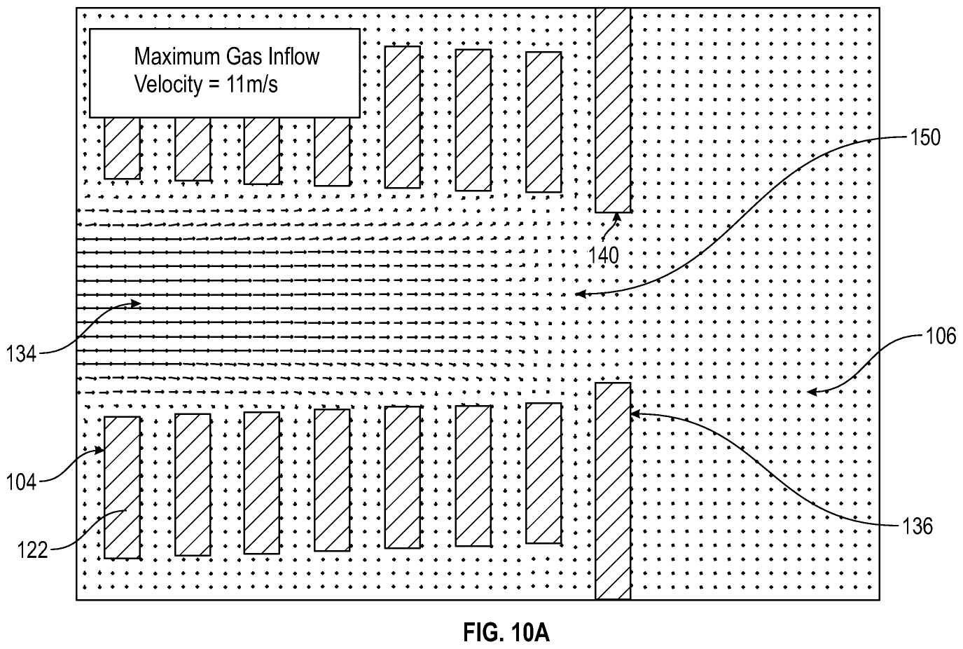

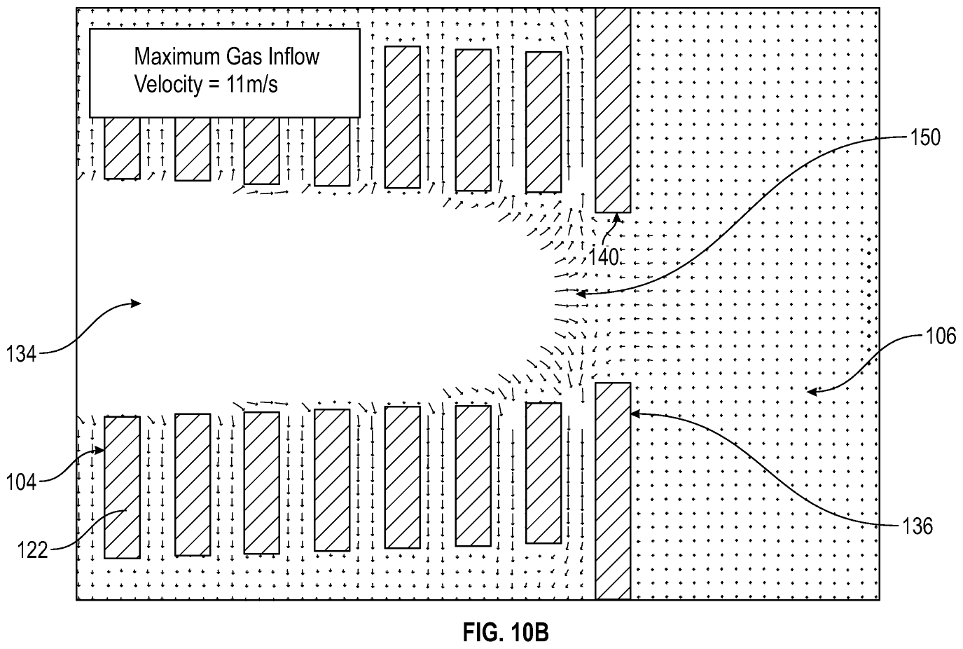

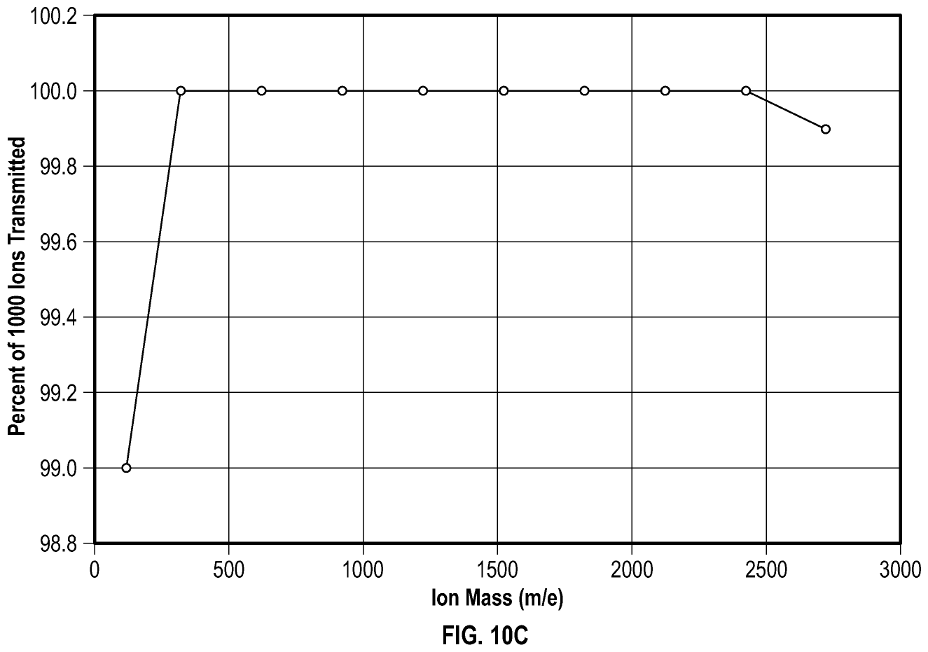

FIGS. 10A and 10B show the partial results of a fourth gas flow velocity simulation for the ion funnel 104 of the present disclosure with a focus at the conductance limit 136 where the pressure within the ion mobility separation device 106 is 2.50 Torr, the pressure applied to the ion funnel chamber 134 by the vacuum system 110 is 2.20 Torr, the temperature of the capillary is 150° C., and the maximum inflow velocity from the ion mobility separation device 106 into the ion funnel chamber 134 is 11 m/s. In FIGS. 10A and 10B, the arrows show the direction of gas flow and the length of the arrows corresponds to the magnitude of the gas flow velocity at that location with the max value scaled to be the distance between plotted data points. Additionally, the arrows shown in FIG. 10B have a max velocity of 40 m/s while the arrows shown in FIG. 10A have a max velocity of 200 m/s, and any data points that have a greater velocity than the max value are omitted. As can be seen, the region of gas flow reversal 150 is very narrow and located close to the conductance limit 136 in the ion funnel chamber 134. Accordingly, the gas within the ion funnel chamber 134 approaches, but does not enter, the ion mobility separation device 106 through the orifice 140 of the conductance limit 136.

FIG. 10C is a chart of ion mass (m/e) versus percentage of 1000 ions transmitted for the simulation of FIGS. 10A and 10B. Additionally, this simulation, of which the results are charted in FIG. 10C, was performed under the following parameters: Guard Voltage=3 V; Capillary Bias=20 V; Funnel Bias=1 V; Funnel Field=2 V/mm; Funnel Exit Bias=20 V; SLIM Bias=0 V; Funnel RF Amplitude=40 V (0-peak); and Funnel RF Frequency=900 kHz, where the Capillary Bias is equal to the difference between the voltage applied to the capillary 120 and the voltage applied to the entrance electrode 130, the Funnel Bias is equal to the difference between the voltage applied to the last electrode 132 and the voltage applied conductance limit 136, and the Funnel Exit Bias is equal to the difference between the voltage applied to the conductance limit 136 and the bias voltage applied to the IMS device 106. As can be seen in the chart of FIG. 10C, ions enter the IMS device 106 through the conductance limit 136 across the entire mass range of the test mixture.

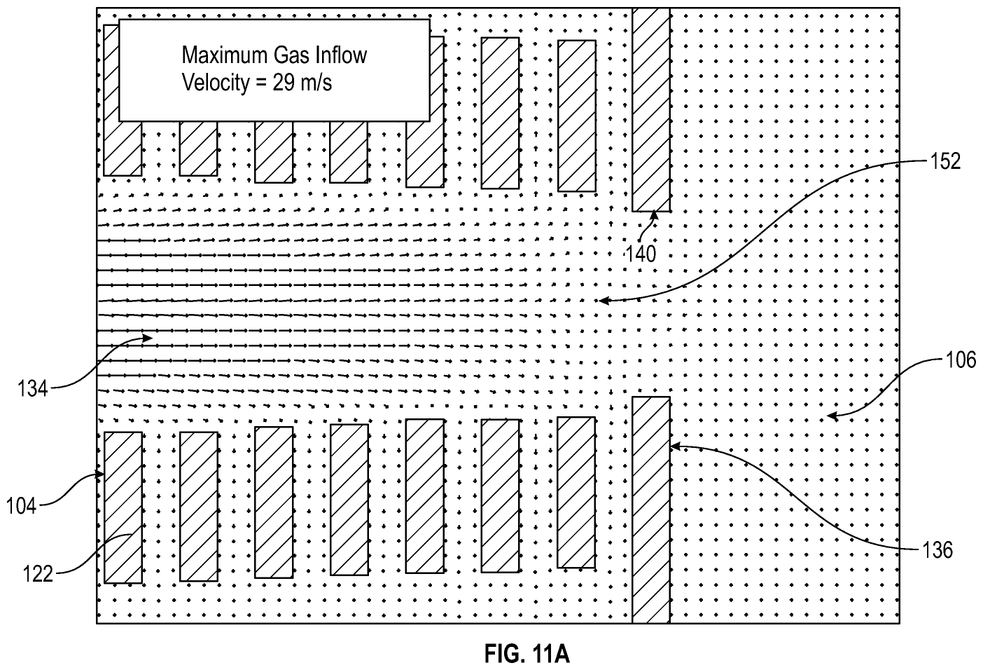

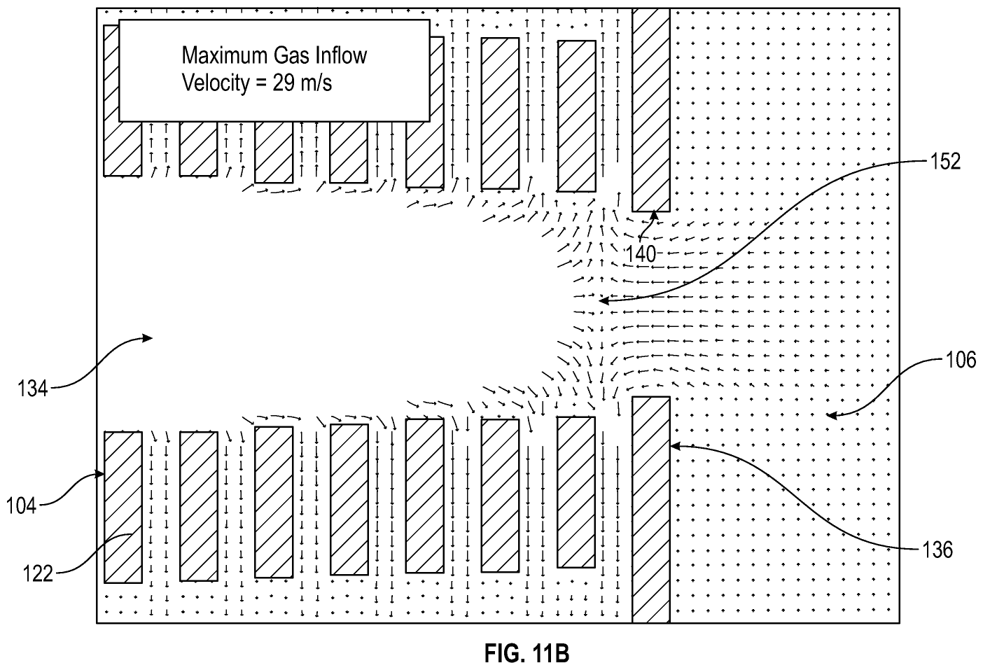

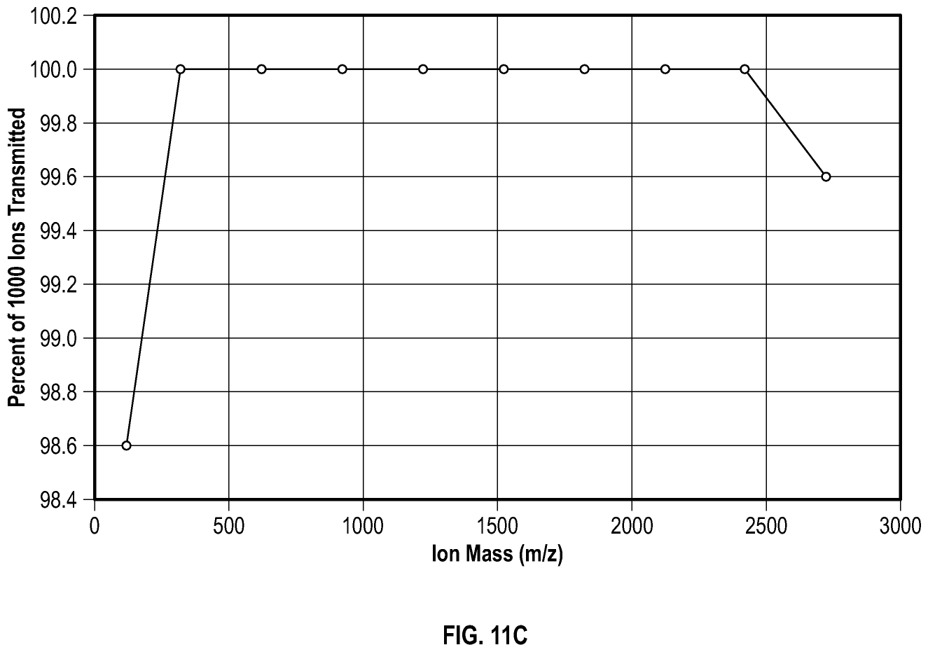

FIGS. 11A and 11B show the partial results of a fifth gas flow velocity simulation for the ion funnel 104 of the present disclosure with a focus at the conductance limit 136 where the pressure within the ion mobility separation device 106 is 2.50 Torr, the pressure applied to the ion funnel chamber 134 by the vacuum system 110 is 2.0 Torr, the temperature of the capillary is 150° C., and the maximum inflow velocity from the ion mobility separation device 106 into the ion funnel chamber 134 is 29 m/s. In FIGS. 11A and 11B, the arrows show the direction of gas flow and the length of the arrows corresponds to the magnitude of the gas flow velocity at that location with the max value scaled to be the distance between plotted data points. Additionally, the arrows shown in FIG. 11B have a max velocity of 40 m/s while the arrows of FIG. 11A have a max velocity of 200 m/s, and any data points that have a greater velocity than the max value are omitted. As can be seen, the region of gas flow reversal 152 is more narrow than that of FIGS. 10A and 10B, and located approximately 1 mm from the conductance limit 136 in the ion funnel chamber 134. Accordingly, the gas within the ion funnel chamber 134 approaches, but does not enter, the ion mobility separation device 106 through the orifice 140 of the conductance limit 136.

FIG. 11C is a chart of ion mass (m/e) versus percentage of 1000 ions transmitted for the simulation of FIGS. 11A and 11B. Additionally, this simulation, of which the results are charted in FIG. 11C, was performed under the following parameters: Guard Voltage=3 V; Capillary Bias=20 V; Funnel Bias=1 V; Funnel Field=2 V/mm; Funnel Exit Bias=20 V; SLIM Bias=0 V; Funnel RF Amplitude=40 V (0-peak); and Funnel RF Frequency=900 kHz. As can be seen in the chart of FIG. 11C, ions enter the IMS device 106 through the conductance limit 136 across the entire mass range of the test mixture.

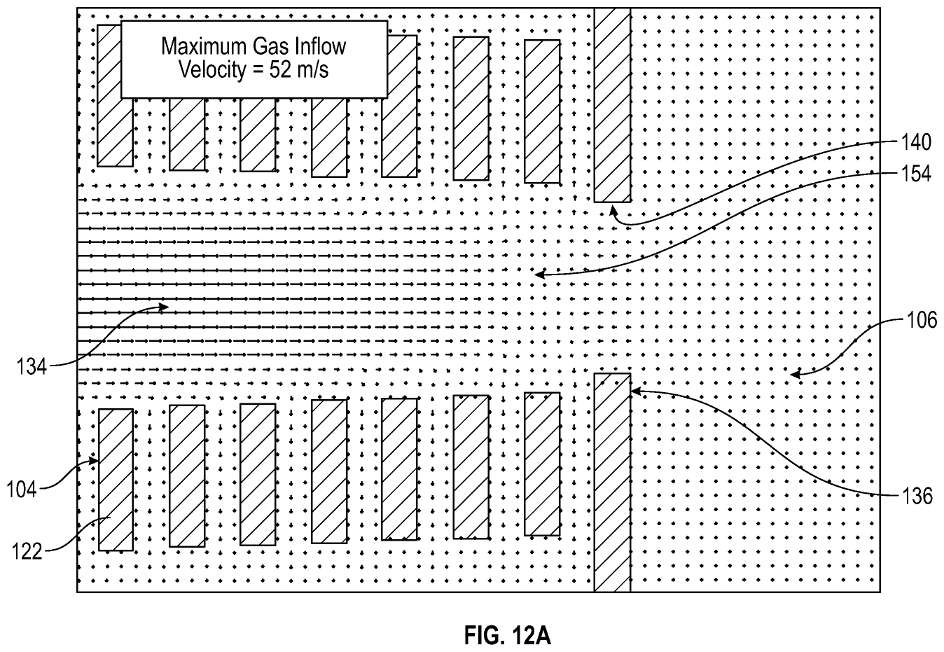

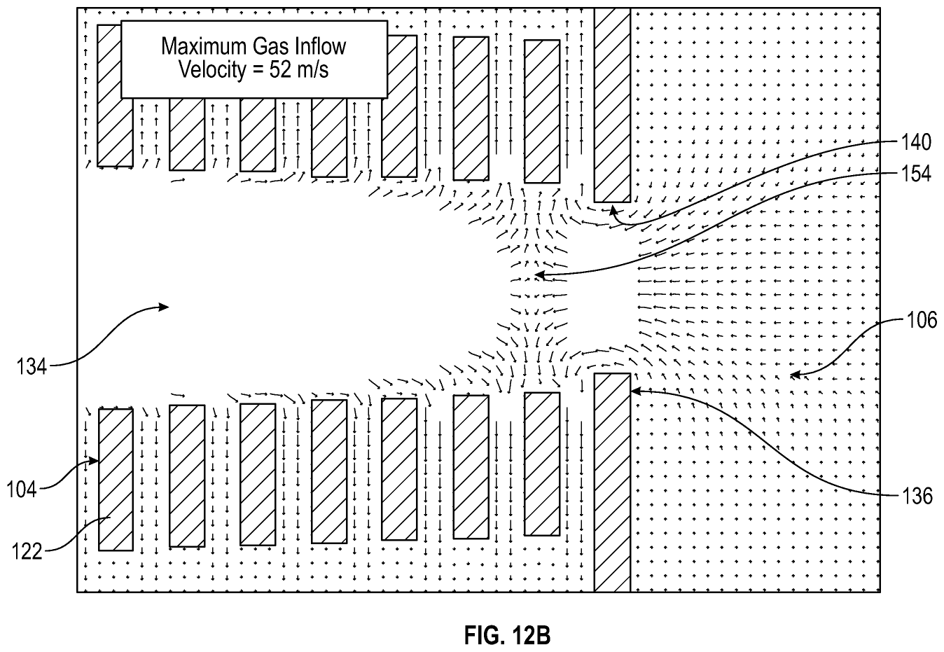

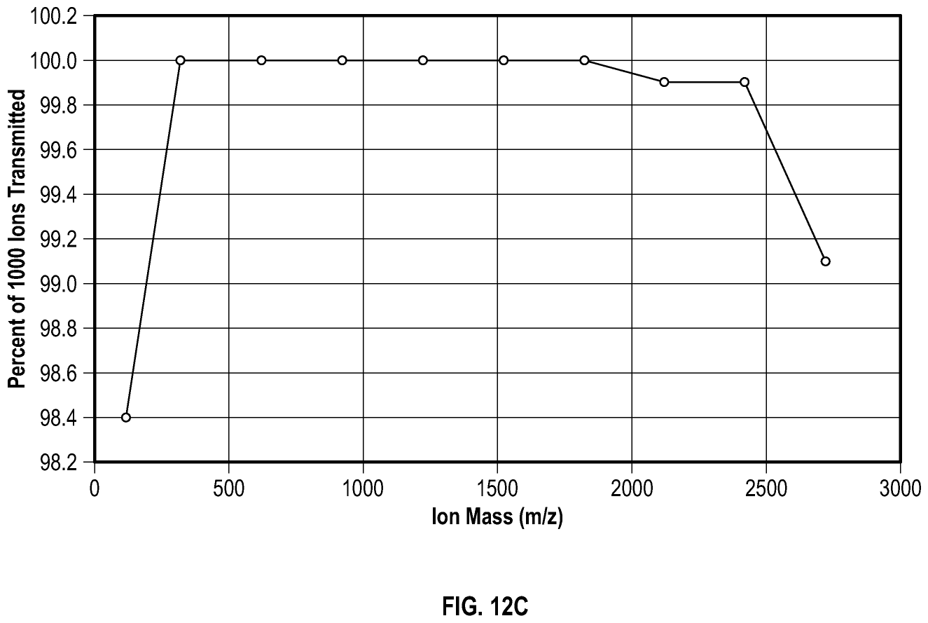

FIGS. 12A and 12B show the partial results of a sixth gas flow velocity simulation for the ion funnel 104 of the present disclosure with a focus at the conductance limit 136 where the pressure within the ion mobility separation device 106 is 2.50 Torr, the pressure applied to the ion funnel chamber 134 by the vacuum system 110 is 1.975 Torr, the temperature of the capillary is 150° C., and the maximum inflow velocity from the ion mobility separation device 106 into the ion funnel chamber 134 is 52 m/s. In FIGS. 12A and 12B, the arrows show the direction of gas flow and the length of the arrows corresponds to the magnitude of the gas flow velocity at that location with the max value scaled to be the distance between plotted data points. Additionally, the arrows shown in FIG. 12B have a max velocity of 40 m/s while the arrows shown in FIG. 12A have a max velocity of 200 m/s, and any data points that have a greater velocity than the max value are omitted. As can be seen, the region of gas flow reversal 154 is narrow like the region 152 of FIGS. 10A and 10B, but located approximately 1.4 mm from the conductance limit 136 in the ion funnel chamber 134. Accordingly, the gas within the ion mobility separation device 106 enters the ion funnel chamber 134, thus preventing the gas within the ion funnel chamber 134 from entering the ion mobility separation device 106 through the orifice 140 of the conductance limit 136.

FIG. 12C is a chart of ion mass (m/e) versus percentage of 1000 ions transmitted for the simulation of FIGS. 12A and 12B. Additionally, this simulation, of which the results are charted in FIG. 12C, was performed under the following parameters: Guard Voltage=3 V; Capillary Bias=20 V; Funnel Bias=1 V; Funnel Field=2 V/mm; Funnel Exit Bias=20 V; SLIM Bias=0 V; Funnel RF Amplitude=40 V (0-peak); and Funnel RF Frequency=900 kHz. As can be seen in the chart of FIG. 12C, ions enter the IMS device 106 through the conductance limit 136 across the entire mass range of the test mixture.

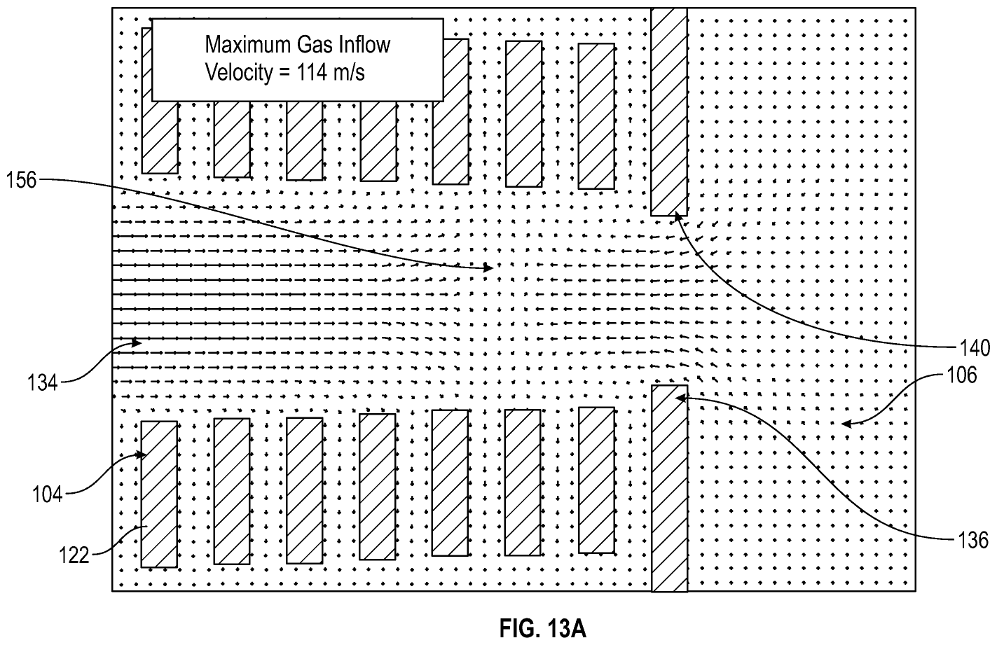

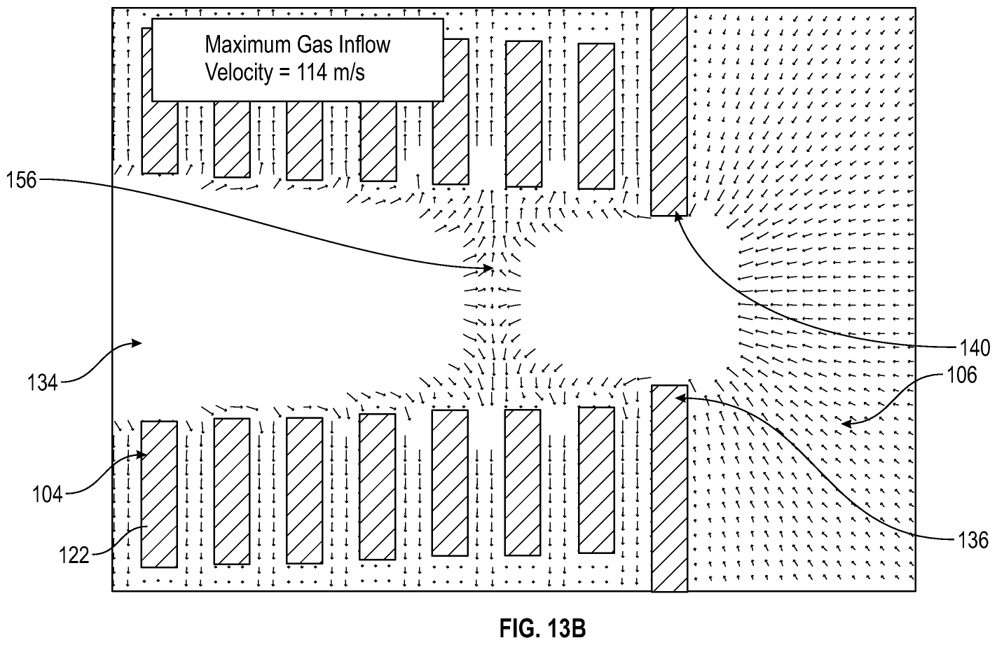

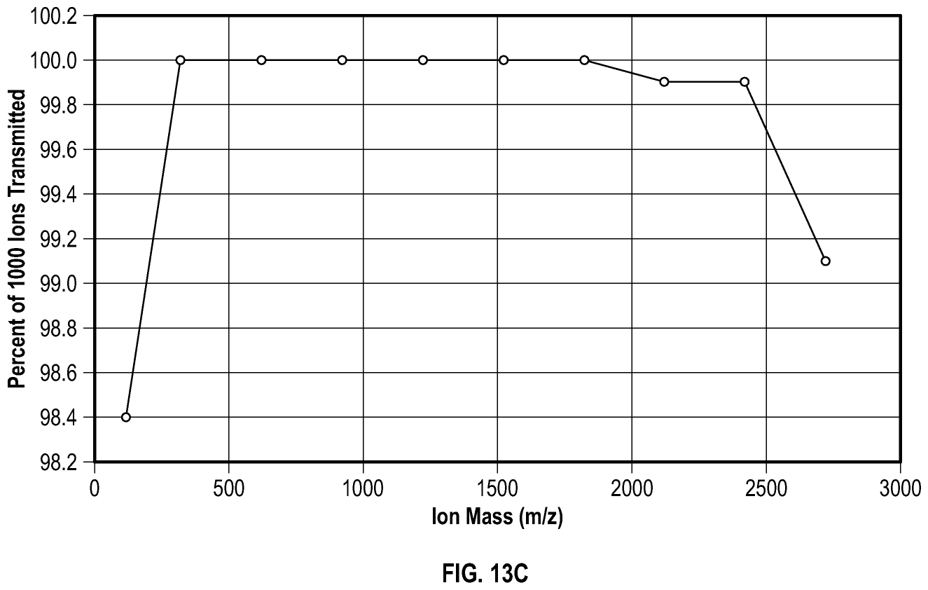

FIGS. 13A and 13B show the partial results of a seventh gas flow velocity simulation for the ion funnel 104 of the present disclosure with a focus at the conductance limit 136 where the pressure within the ion mobility separation device 106 is 2.50 Torr, the pressure applied to the ion funnel chamber 134 by the vacuum system 110 is 1.9 Torr, the temperature of the capillary is 150° C., and the maximum inflow velocity from the ion mobility separation device 106 into the ion funnel chamber 134 is 114 m/s. In FIGS. 13A and 13B, the arrows show the direction of gas flow and the length of the arrows corresponds to the magnitude of the gas flow velocity at that location with the max value scaled to be the distance between plotted data points. Additionally, the arrows shown in FIG. 13B have a max velocity of 40 m/s while the arrows shown in FIG. 13A have a max velocity of 200 m/s, and any data points that have a greater velocity than the max value are omitted. As can be seen, the region of gas flow reversal 156 is narrow like the region 152 of FIGS. 10A and 10B, but located even further from the conductance limit 136 within the ion funnel chamber 134. Accordingly, the gas within the ion mobility separation device 106 enters the ion funnel chamber 134, thus preventing the gas within the ion funnel chamber 134 from entering the ion mobility separation device 106 through the orifice 140 of the conductance limit 136.

FIG. 13C is a chart of ion mass (m/e) versus percentage of 1000 ions transmitted for the simulation of FIGS. 13A and 13B. Additionally, this simulation, of which the results are charted in FIG. 13C, was performed under the following parameters: Guard Voltage=3 V; Capillary Bias=20 V; Funnel Bias=1 V; Funnel Field=2 V/mm; Funnel Exit Bias=20 V; SLIM Bias=0 V; Funnel RF Amplitude=40 V (0-peak); and Funnel RF Frequency=900 kHz. As can be seen in the chart of FIG. 13C, ions enter the IMS device 106 through the conductance limit 136 across the entire mass range of the test mixture.

Additional simulations were performed for the ion funnel 104 of FIG. 3 to determine the percentage of different ions transmitted for different ion funnel RF amplitudes and ion funnel RF frequencies. For example, Tables 1 and 2 show the results of two simulation performed with the following ion funnel 104 parameters:

Inner diameter of the entrance electrode 130=10 mm;

Inner diameter of the last electrode 132=3 mm;

Inner diameter of the orifice 140=2.464 mm;

Guard voltage=3 V;

Capillary bias=20 V;

Ion funnel 104 bias=1 V;

Ion funnel 104 field=2 V/mm;

Ion funnel 104 exit bias=20 V; and

IMS device 106 bias=0 V.

In particular, Table 1 shows the percentage of two-hundred 118 amu ions and two-hundred 2722 amu ions that are transmitted through the ion funnel 104 and into the IMS device 106 for all permutations of three different ion funnel RF frequencies and three different ion funnel RF amplitudes:

TABLE 1

| | Ion Funnel | | | | | | |
|---|---|---|---|---|---|---|---|
| | RF | | | | | | |
| | Frequency | | | | | | |
| | (kHz) | 600 kHz | | 800 kHz | | 1000 kHz | |
| | Ion Mass | 118 | 2722 | 118 | 2722 | 118 | 2722 |
| | (amu) | amu | amu | amu | amu | amu | amu |
| Funnel RF | * | * | * | * | * | * | * |
| Amplitude | | | | | | | |
| (V (0-p)) | | | | | | | |
| 30 V | * | 84.0% | 100.0% | 94.0% | 97.5% | 99.5% | 53.5% |
| 40 V | * | 81.5% | 100.0% | 97.5% | 100.0% | 99.5% | 99.5% |
| 50 V | * | 77.0% | 100.0% | 96.0% | 100.0% | 99.0% | 100.0% |
| * | Average | 80.8% | 100.0% | 95.8% | 99.2% | 99.3% | 84.3% |
| | Percentage | | | | | | |

Table 2 shows the percentage of two-hundred 118 amu ions, two-hundred 322 amu ions, two-hundred 922 amu ions, two-hundred 1822 amu ions, and two-hundred 2722 amu ions that are transmitted through the ion funnel 104 and into the IMS device 106 for three different ion funnel RF amplitudes, namely, 30 V, 40 V, and 50V, and an ion funnel RF frequency of 900 kHz:

TABLE 2

| | Ion Funnel | | | | |
|---|---|---|---|---|---|
| | RF | | | | |
| | Amplitude | | | | |
| | (V (0-p)) | 30 V | 40 V | 50 V | |
| Ion Mass | * | * | * | * | Average |
| (amu) | | | | | Percentage |
| 118 amu | * | 99.5% | 99.0% | 97.5% | 98.7% |
| 322 amu | * | 100.0% | 100.0% | 100.0% | 100.0% |
| 922 amu | * | 100.0% | 100.0% | 100.0% | 100.0% |
| 1822 amu | * | 100.0% | 100.0% | 100.0% | 99.2% |
| 2722 amu | * | 83.0% | 100.0% | 100.0% | 94.3% |
| * | Average | 96.5% | 99.8% | 99.5% | 98.6% |
| | Percentage | | | | |

As can be seen from Table 1, when the ion funnel RF frequency is at 600 kHz the 118 amu ions are in a region of instability as some of those ions are ejected. However, transmission of the 118 amu ions improves with increasing RF frequency, but a portion of the 2722 amu ions are lost as the RF frequency is increased due to inadequate trapping force at the ion funnel electrodes 122. As can be seen in Table 2, an ion funnel RF frequency of 900 kHz is a good compromise as it produces adequate transmission over the entire mass range of ions at an ion funnel RF amplitude of 40 V.

As is evident from the foregoing disclosure, the ion funnel 104 and IMS device 106 can be configured so that gas, e.g., nitrogen gas, from the IMS device 106 enters the ion funnel 104 through the orifice 140 of the conductance limit 136 at a predetermined velocity. Gas entering into the ion funnel 104 flows counter to the DC gradient applied to the electrodes 122 and thus counter to the direction of ion travel. For example, FIG. 14 is an enlarged view of Area A-A of FIG. 3 showing details of the ion funnel 104, the conductance limit 136, and the ion mobility separation device 106 of the present disclosure, and illustrating the direction of ion flow through the ion funnel 104 and the direction of gas flow from the IMS device 106. In particular, the ions flow in the direction of Arrow A, e.g., along the central axis of the ion funnel 104 toward the conductance limit 136 and through the orifice 140 into the IMS device 106, while the gas from the IMS device 106, e.g., from the chamber 107 in which IMS device 106 is housed, flows in the direction of Arrows B and C, e.g., through the orifice 140 of the conductance limit 136 and into the ion funnel 104.

Accordingly, as the ions are transmitted across the ion funnel 104 and through the conductance limit 136 they encounter a headwind, which increases the number of collisions between ions and with the gas molecules entering from the IMS device 106. These collisions can be harnessed to provide utility as the ions discharged by the capillary 120 often have extra salts, water, or solvent molecules adducted thereto, which can be stripped by the collisions. That is, by increasing the number of collisions occurring between ions and/or gas molecules as the ions are transmitted across the ion funnel 104 and through the conductance limit 136 into the IMS device 106, the extra salts, water, or solvent molecules adducted to the ions can be stripped therefrom, which enables the detection of the ions in their native ion form, e.g., native mass spectrometry can be conducted.

The foregoing can be achieved by the present disclosure by varying the DC gradient applied to electrodes 122 of the ion funnel 104, which alters the velocity of the ions, and/or varying the inflow velocity of gas from the IMS device 106 to adjust the force in which the ions are colliding, e.g., impacting the gas molecules. The inflow velocity of gas entering the ion funnel 104 from the IMS device 106 can be adjusted by, for example, changing the pressure within the chamber 107 of the IMS device 106 and/or changing the pressure within the ion funnel 104 through control of the vacuum system 110 by the pressure control module 114.

Additionally, since the chamber 107 of the IMS device 106 is back-filled with gas, e.g., nitrogen gas, the ions being transmitted from the ion funnel 104 into the IMS device 106 must overcome the pressure of the IMS device 106 in order to enter the IMS device chamber. In order to do so, an electric field is generated between the last electrode 132 and the conductance limit 136 and/or between the conductance limit 136 and the IMS device 106 which forces the ions into the IMS device 106. This functionality can be used as a low-pass filter to control which ions exit the ion funnel 104 and are transferred to the IMS device 106. Specifically, larger ions, e.g., ions having a larger collision cross section, will experience more drag from the gas entering the ion funnel 104 from the IMS device 106 than smaller ions, and will therefore require a greater electric field, e.g., between the last electrode 132 and the conductance limit 136 or between the conductance limit 136 and the IMS device 106, in order to overcome the pressure from the IMS device chamber 107. The voltage bias applied to electrodes 122, the conductance limit 136, and the IMS device 106 can be controlled and adjusted so that ions over a certain size, e.g., collision cross section, are not able to overcome the pressure from the chamber 107 housing the IMS device 106 and do not pass through the conductance limit 136. That is, larger ions can be prevented from exiting the ion funnel 104 and entering the IMS device 106 by controlling the voltage bias applied to the electrodes 122, the conductance limit 136, and/or the IMS device 106, as well as the pressure differential between the ion funnel 104 and the chamber 107 housing the IMS device 106, e.g., by changing the pressure within the chamber 107 housing the IMS device 106 and/or changing the pressure within the ion funnel vacuum chamber 105 through control of the vacuum system 110.

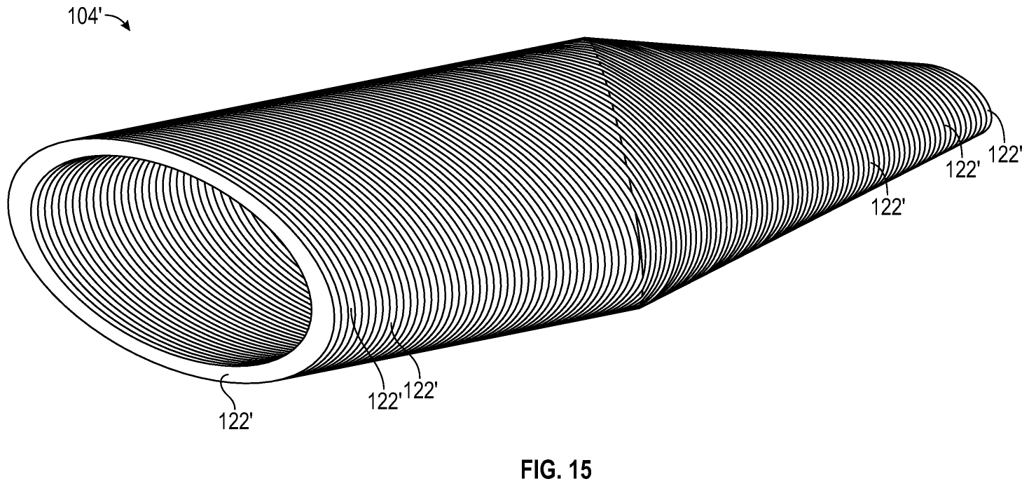

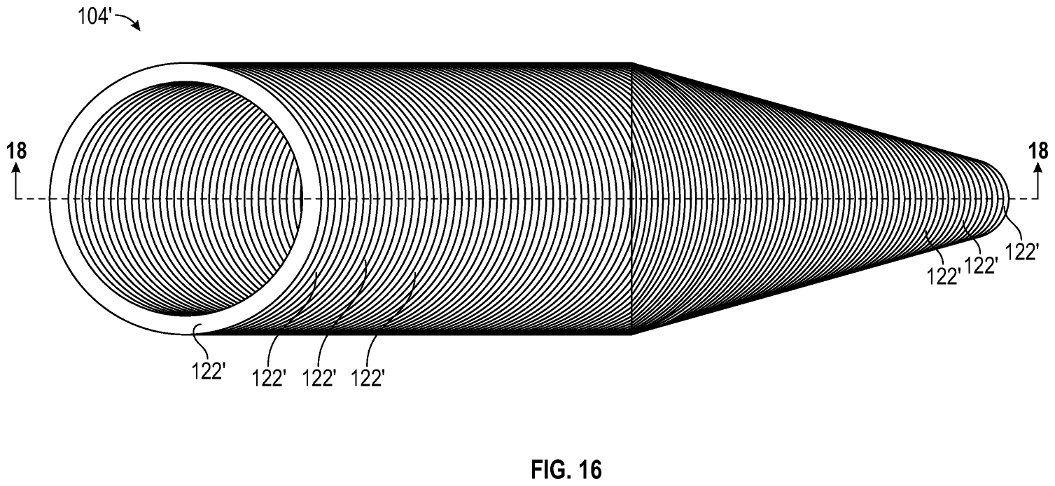

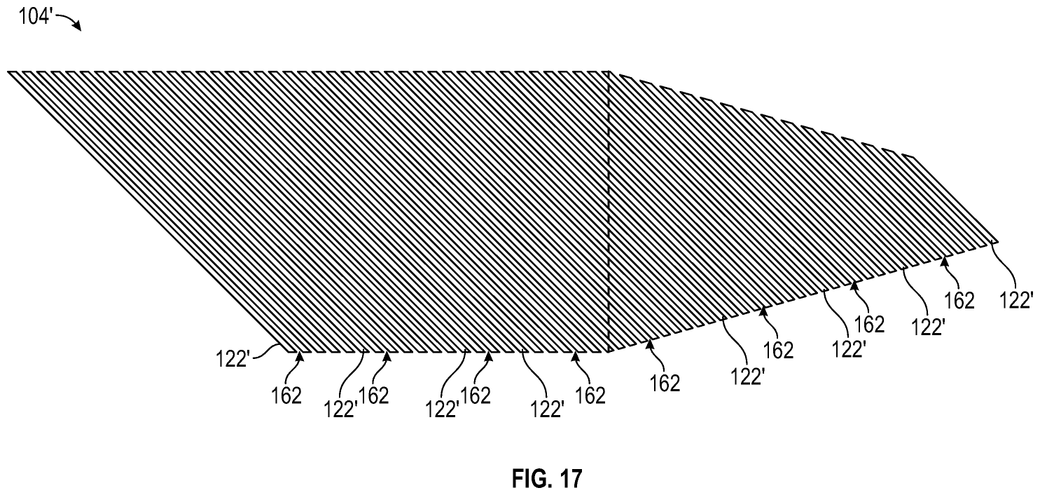

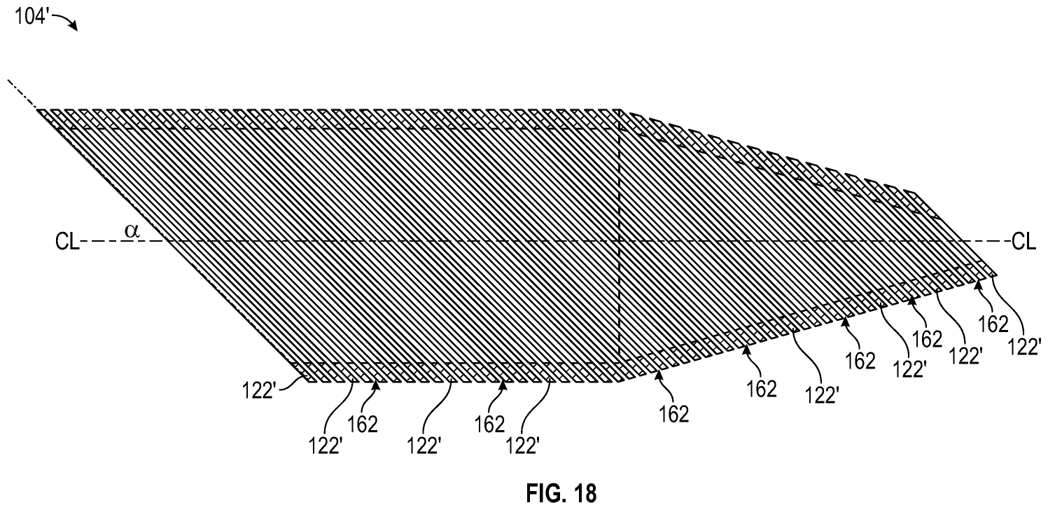

FIGS. 15-18 illustrate an alternative ion funnel 104′ of the present disclosure. Specifically, FIG. 15 is a top rear perspective view of the alternative ion funnel 104′, FIG. 16 is a bottom plan view of the alternative ion funnel 104′ of FIG. 15, FIG. 17 is a side elevational view of the alternative ion funnel 104′ of FIG. 15, and FIG. 18 is a sectional view of the alternative ion funnel 104′ taken along line 18-18 of FIG. 16.

The alternative ion funnel 104′ can be similar in size and construction to the ion funnel 104 shown in and described in connection with FIG. 3; however, the ion funnel 104′ of FIGS. 15-17 includes a plurality of stacked ring electrodes 122′ that are tilted, as opposed to vertically positioned, such that they create an angle α with respect to the central axis CL of the ion funnel 104′ that is less than 90°. For example, each of the stacked ring electrodes 122′ can be tilted at a 45° angle with respect to the central axis CL. In this regard, the stacked ring electrodes 122′ are slanted rearward, e.g., away from the direction of ion travel, so that an angled channel 162 is created between each adjacent stacked ring electrode 122′. This essentially creates a series of baffles that improves conductance of gas out of the ion funnel 104′ as the angled ring electrodes 122′ and angled channels 162 allow additional gas to flow between adjacent stacked ring electrodes 122′ and be exhausted from the ion funnel 104′.

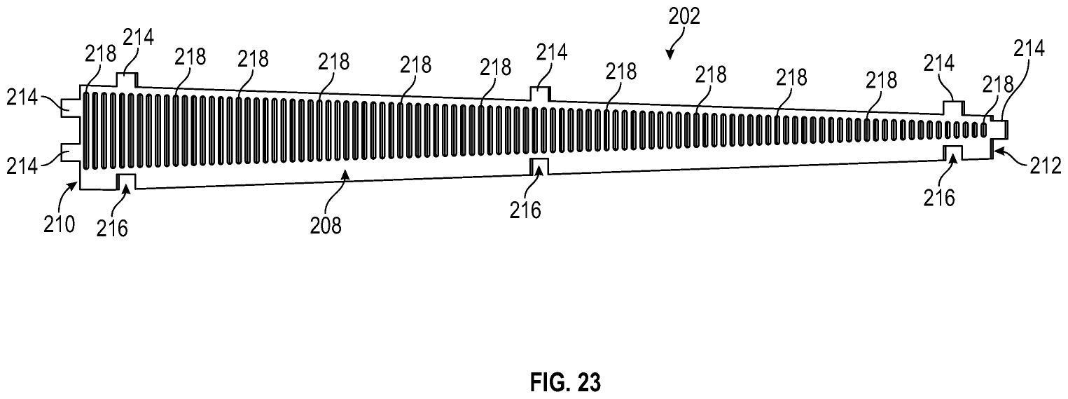

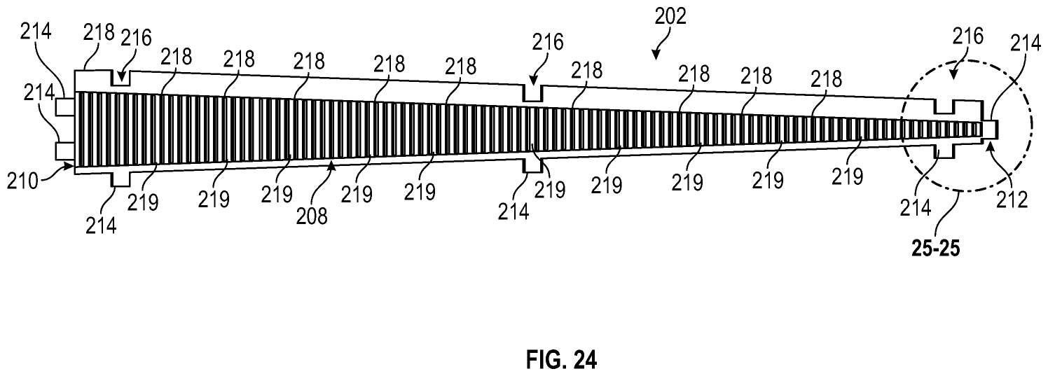

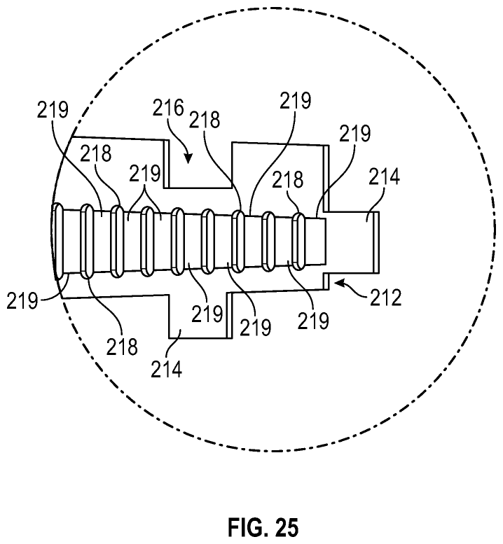

FIGS. 19-22 are, respectively, front perspective, rear perspective, side elevational, and front elevational views of another exemplary ion funnel 200 of the present disclosure. FIGS. 23 and 24 are, respectively, top and bottom plan views of a PCB 202 utilized with the ion funnel 200 of FIGS. 19-22, while FIG. 25 is a detailed view of Area 25-25 of FIG. 24. The ion funnel 200 can be similar to the ion funnel 104 shown and described in connection with FIG. 3, but utilizing four PCBs 202 having electrodes 204 thereon in place of the electrodes 122.

The ion funnel 200 includes four interlocking PCBs 202, a front mounting plate 204, and a rear mounting plate 206. Each of the interlocking PCBs 202 (see FIGS. 23-25) includes a body 208 that reduces in width from a first end 210 to a second end 212, and includes a plurality of tabs 214, a plurality of recesses 216, and a plurality of spaced openings 218 extending there through. The plurality of openings 218 can be spaced from each other longitudinally along the length of the PCB 202. Each PCB 202 also includes a plurality of electrodes 219 on a surface thereof, e.g., mounted, deposited, etched, etc. As shown in FIGS. 24 and 25, the electrodes 219 can be elongated across a width of the PCB body 208 and spaced from each another longitudinally along a length of the PCB body 208. In this regard, each of the electrodes 219 can be positioned between two adjacent openings 218. The electrodes 219 are configured to receive RF and/or DC voltage signals in similar fashion to the electrodes 122 of the ion funnel 104 shown and described in connection with FIG. 3. Accordingly, the discussion provided in connection with FIG. 3 should be understood to equally apply to the ion funnel 200 and electrodes 219 shown and described in connection with FIGS. 19-25, and need not be repeated. Additionally and/or alternatively, the electrodes 219 could be similar to those described in U.S. Pat. No. 9,824,874, entitled “Ion Funnel Device,” the disclosure of which is incorporated herein by reference.

The front mounting plate 204 includes a body 220 having an orifice 222, a plurality of PCB mounting holes 224, and a plurality of ion funnel mounting holes 226. The front mounting plate 204 can be a conductance limit orifice plate configured to interlock with the PCBs 202 and be mounted to an IMS device 106, e.g., via the ion funnel mounting holes 226 and fasteners (not shown). The rear mounting plate 206 similarly includes a body 228 having an opening 230, a plurality of PCB mounting holes 232, and a plurality of ion funnel mounting holes 234. The rear mounting plate 204 is configured to interlock with the PCBs 202 and be mounted to an ionization source 102, e.g., via the ion funnel mounting holes 226 and fasteners (not shown).

The four PCBs 202 can be interconnected by serially engaging the tabs 214 of one PCB 202 with the recesses 216 of another PCB 202 to form a four-sided truncated pyramid shape defining an internal chamber 236 that has a generally square cross-section. When the PCBs 202 are interconnected, the electrodes 219 are positioned facing into the interior of the ion funnel 200, e.g., in the direction of the internal chamber 236. The tabs 214 located at the first ends 210 of the PCBs 202 can be inserted into the PCB mounting holes 232 of the rear mounting plate 206 and the tabs 214 located at the second ends 212 of the PCBs can be inserted into the PCB mounting holes 224 of the front mounting plate 204 to secure the PCBs 202 to the front and rear mounting plates 204, 206 and fully form the ion funnel 200. It should be understood that more or less than four PCBs 202 can be implemented to form the ion funnel 200, and the PCBs 202 can include different shapes in order to modify the shape and geometry of the internal chamber 236 as desired.

As noted above, the PCBs 202 reduce in width from the first end 210 to the second end 212 such that the ion funnel 202 has a truncated pyramidal shape. Accordingly, the internal chamber 236 similarly has a truncated pyramidal shape having a generally square cross-section that reduces in a first dimension D₁, e.g., height, and a second dimension D₂, e.g., width, from the first end 210 to the second end 212. As such, similar to the ion funnel 104 shown and described in connection with FIG. 3, the internal chamber 236 can be characterized as having a taper angle or convergence angle α, which can be defined between opposing PCBs 202. That is, the convergence angle α can be understood to be the angle formed between opposing PCBs 202. The convergence angle α of the ion funnel 200 of the present disclosure is equal to or less than approximately 30° for a majority of the length of the internal chamber 236, and in some instances less than 20°. It is also noted that the convergence angle α can be different for the different PCBs 202 and electrodes 219, but is generally equal to or less than approximately 30° in both instances. Additionally, the funnel shape formed by the reduction in first and second inner dimensions D₁ and D₂ can have a slope parameter, which for each PCB 202 can be defined as the slope of the PCB 202 with respect to the ion funnel central axis B. For example, this can be calculated as half the difference between either the first or second inner dimension D₁, D₂ at the first end 210 and the first or second inner dimension D₁, D₂ at the second end 212 divided by a length L of the PCBs 202. The slope parameter for each PCB 202 of the ion funnel 200 of the present disclosure is equal to or less than approximately 0.27, or in some instances equal to or less than approximately 0.18.

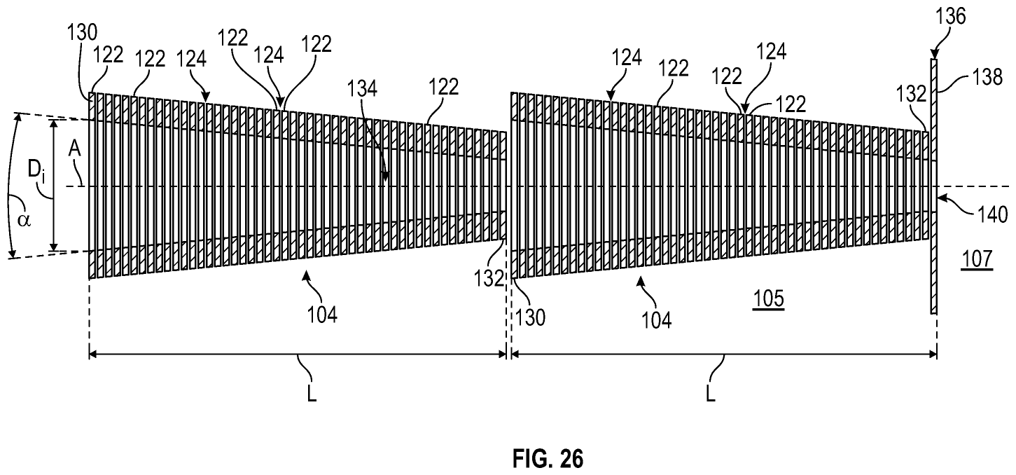

FIG. 26 is a sectional view of a dual ion funnel system of the present disclosure that includes two ion funnels 104 arranged in series. Each of the ion funnels 104 can be substantially similar in size, shape, and construction to the ion funnel 104 shown and described in connection with FIG. 3. The ion funnels 104 are arranged such that the last electrode 132 of the upstream funnel 104 is adjacent the entrance electrode 130 of the downstream funnel 104. Accordingly, the upstream ion funnel 104 discharges ions into the downstream ion funnel 104, which in turn discharges ions through the conductance limit orifice plate 136 and into a subsequent chamber and device, e.g., an IMS device 106. It should be understood that one or more electrodes 122 of the upstream ion funnel 104 can be positioned within the downstream funnel 104, e.g., within the central opening 128 of one or more electrodes 122. Additionally, while the two ion funnels 104 are shown as aligned in the y-axis, it should be understood that the upstream ion funnel 104 can be shifted along the y-axis or the z-axis so that it is offset from the downstream ion funnel 104 and not coaxial therewith. It should also be understood that while a conductance limit orifice plate 136 is not shown between the upstream ion funnel 104 and the downstream ion funnel 104, one could be provided there between if so desired, e.g., between the last electrode 132 of the upstream funnel 104 and the entrance electrode 130 of the downstream funnel 104, to further mitigate any turbulence or local high pressures in the downstream ion funnel 104.

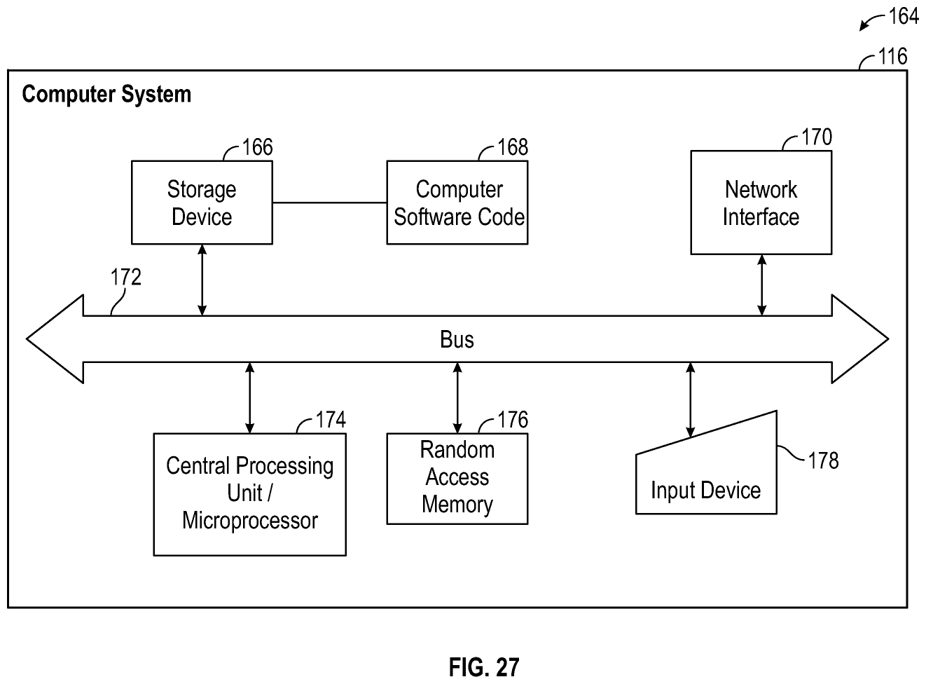

FIG. 27 is a diagram 164 showing hardware and software components of the computer system 116 on which aspects of the present disclosure can be implemented. The computer system 116 can include a storage device 166, computer software code 168, a network interface 170, a communications bus 172, a central processing unit (CPU) (microprocessor) 174, random access memory (RAM) 176, and one or more input devices 178, such as a keyboard, mouse, etc. It is noted that the CPU 174 could also include, or be configured as, one or more graphics processing units (GPUs). The computer system 116 could also include a display (e.g., liquid crystal display (LCD), cathode ray tube (CRT), and the like). The storage device 166 could comprise any suitable computer-readable storage medium, such as a disk, non-volatile memory (e.g., read-only memory (ROM), erasable programmable ROM (EPROM), electrically-erasable programmable ROM (EEPROM), flash memory, field-programmable gate array (FPGA), and the like). The computer system 116 could be a networked computer system, a personal computer, a server, a smart phone, tablet computer, etc.

The functionality provided by the present disclosure could be provided by the computer software code 168, which each could be embodied as computer-readable program code (e.g., algorithm) stored on the storage device 166 and executed by the computer system 116 using any suitable, high or low level computing language, such as Python, Java, C, C++, C#, .NET, MATLAB, etc. A network interface 170 could include an Ethernet network interface device, a wireless network interface device, or any other suitable device which permits the computer system 116 to communicate via a network. The CPU 174 could include any suitable single-core or multiple-core microprocessor of any suitable architecture that is capable of implementing and running the computer software code 168 (e.g., Intel processor). The random access memory 176 could include any suitable, high-speed, random access memory typical of most modern computers, such as dynamic RAM (DRAM), etc.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. An ion funnel, comprising:
an entrance electrode defining a first opening having a first inner dimension;
a last electrode defining a second opening having a second inner dimension that is smaller than the first inner dimension;
a plurality of intermediate electrodes positioned between the entrance electrode and the last electrode, each of the plurality of intermediate electrodes defining an associated opening having an associated inner dimension, the associated inner dimensions progressively reducing in size from approximately the first inner dimension to approximately the second inner dimension; and
an internal chamber defined by the first opening, the associated openings of the plurality of intermediate electrodes, and the second opening, the internal chamber having an outer dimension reducing at a convergence angle from the first inner dimension to the second inner dimension, the convergence angle being less than 30 degrees for at least a majority of a length of the internal chamber,
wherein at least a portion of the plurality of intermediate electrodes receive a radio frequency (RF) voltage configured to confine ions received by the ion funnel.

2. The ion funnel of claim 1, comprising a space between each of the plurality of intermediate electrodes configured to permit gas to be extracted from the ion funnel.

3. The ion funnel of claim 1, comprising a conductance limit including an orifice, the conductance limit positioned adjacent the last electrode and separating the ion funnel from a downstream device having a pressure greater than a pressure of the ion funnel, the greater pressure of the downstream device causing gas from the downstream device to enter the ion funnel.

4. The ion funnel of claim 3, wherein the ion funnel is configured to generate an electric field that urges the ions through the orifice of the conductance limit and causes the ions to enter the downstream device.

5. The ion funnel of claim 4, wherein the downstream device is an ion mobility device.

6. The ion funnel of claim 1, wherein each of the plurality of intermediate electrodes is slanted at an angle with respect to a central axis of the ion funnel, the angle being greater than or less than 90 degrees.

7. An ion funnel, comprising:
an entrance electrode defining a first opening having a first inner dimension;
a last electrode defining a second opening having a second inner dimension that is smaller than the first inner dimension; and
a plurality of intermediate electrodes positioned between the entrance electrode and the last electrode, each of the plurality of intermediate electrodes defining an associated opening having an associated inner dimension, the associated inner dimensions progressively reducing in size from approximately the first inner dimension to approximately the second inner dimension,
wherein each of the intermediate electrodes defines a slope parameter with respect to an adjacent intermediate electrode,
wherein the slope parameter of at least a majority of the intermediate electrodes with respect to the respective adjacent electrode is less than 0.27, and
wherein at least a portion of the plurality of intermediate electrodes receive a radio frequency (RF) voltage configured to confine ions received by the ion funnel.

8. The ion funnel of claim 7, wherein the slope parameter is defined as half the difference between the associated inner dimension of the intermediate electrode and the associated inner dimension of the adjacent intermediate electrode divided by a distance between the intermediate electrode and the adjacent intermediate electrode

9. The ion funnel of claim 7, comprising:
a length measured from the entrance electrode to the last electrode; and
a second slope parameter defined as half the difference between the first inner dimension and the second inner dimension divided by the length, wherein the second slope parameter is less than 0.27.

10. The ion funnel of claim 7, comprising an internal chamber defined by the first opening, the associated openings of the plurality of intermediate electrodes, and the second opening, the internal chamber having an outer dimension reducing at a convergence angle from the first inner dimension to the second inner dimension, the convergence angle being less than 30 degrees for at least a majority of a length of the internal chamber,

11. The ion funnel of claim 7, comprising a space between each of the plurality of intermediate electrodes configured to permit gas to be extracted from the ion funnel.

12. The ion funnel of claim 7, comprising a conductance limit including an orifice, the conductance limit positioned adjacent the last electrode and separating the ion funnel from a downstream device having a pressure greater than a pressure of the ion funnel, the greater pressure of the downstream device causing gas from the downstream device to enter the ion funnel.

13. The ion funnel of claim 11, wherein the ion funnel is configured to generate an electric field that urges the ions through the orifice of the conductance limit and causes the ions to enter the downstream device.

14. The ion funnel of claim 12, wherein the downstream device is an ion mobility device.

15. The ion funnel of claim 7, wherein each of the plurality of intermediate electrodes is slanted at an angle with respect to a central axis of the ion funnel, the angle being greater than or less than 90 degrees.

16. An ion funnel system, comprising:
a first ion funnel, comprising:
a first entrance electrode defining a first opening having a first inner dimension;
a first last electrode defining a second opening having a second inner dimension that is smaller than the first inner dimension;
a first plurality of intermediate electrodes positioned between the first entrance electrode and the first last electrode, each of the first plurality of intermediate electrodes defining an associated first opening having an associated first inner dimension, the associated first inner dimensions progressively reducing in size from approximately the first inner dimension to approximately the second inner dimension; and
a first internal chamber defined by the first opening, the associated first openings of the first plurality of intermediate electrodes, and the second opening, the first internal chamber having an outer dimension reducing at a first convergence angle from the first inner dimension to the second inner dimension, the first convergence angle being less than 30 degrees for at least a majority of a length of the first internal chamber; and
a second ion funnel, comprising:
a second entrance electrode defining a third opening having a third inner dimension;
a second last electrode defining a fourth opening having a fourth inner dimension that is smaller than the third inner dimension;
a second plurality of intermediate electrodes positioned between the second entrance electrode and the second last electrode, each of the second plurality of intermediate electrodes defining an associated second opening having an associated second inner dimension, the associated second inner dimensions progressively reducing in size from approximately the third inner dimension to approximately the fourth inner dimension; and
a second internal chamber defined by the third opening, the associated second openings of the second plurality of intermediate electrodes, and the fourth opening, the second internal chamber having an outer dimension reducing at a first convergence angle from the third inner dimension to the fourth inner dimension, the second convergence angle being less than 30 degrees for at least a majority of a length of the second internal chamber,
wherein at least a portion of the first plurality of intermediate electrodes receive a first radio frequency (RF) voltage configured to confine ions received by the first ion funnel, and at least a portion of the second plurality of intermediate electrodes receive a second RF voltage configured to confine ions received by the second ion funnel.

17. The ion funnel system of claim 16, comprising a space between each of the first plurality of intermediate electrodes configured to permit gas to be extracted from the first ion funnel and a space between each of the second plurality of intermediate electrodes configured to permit gas to be extracted from the second ion funnel.

18. The ion funnel system of claim 16, comprising a conductance limit including an orifice, the conductance limit positioned adjacent the second last electrode and separating the second ion funnel from a downstream device having a pressure greater than a pressure of the second ion funnel, the greater pressure of the downstream device causing gas from the downstream device to enter the second ion funnel.

19. The ion funnel system of claim 18, wherein the second ion funnel is configured to generate an electric field that urges the ions through the orifice of the conductance limit and causes the ions to enter the downstream device.

20. The ion funnel system of claim 19, wherein the downstream device is an ion mobility device.

21. An ion funnel system, comprising:
a first ion funnel, including:
a first entrance electrode defining a first opening having a first inner dimension;
a first last electrode defining a second opening having a second inner dimension that is smaller than the first inner dimension; and
a first plurality of intermediate electrodes positioned between the first entrance electrode and the first last electrode, each of the first plurality of intermediate electrodes defining a first associated opening having a first associated inner dimension, the first associated inner dimensions progressively reducing in size from approximately the first inner dimension to approximately the second inner dimension; and
a second ion funnel, including:
a second entrance electrode defining a third opening having a third inner dimension;
a second last electrode defining a fourth opening having a fourth inner dimension that is smaller than the third inner dimension; and
a second plurality of intermediate electrodes positioned between the second entrance electrode and the second last electrode, each of the second plurality of intermediate electrodes defining a second associated opening having a second associated inner dimension, the second associated inner dimensions progressively reducing in size from approximately the third inner dimension to approximately the fourth inner dimension,
wherein each of the first intermediate electrodes defines a first slope parameter with respect to an adjacent first intermediate electrode and each of the second intermediate electrodes defines a second slope parameter with respect to an adjacent second intermediate electrode,
wherein the first slope parameter of at least a majority of the first intermediate electrodes with respect to the respective adjacent first intermediate electrode is less than 0.27 and the second slope parameter of at least a majority of the second intermediate electrodes with respect to the respective adjacent second intermediate electrode is less than 0.27,
wherein at least a portion of the first plurality of intermediate electrodes receive a first radio frequency (RF) voltage configured to confine ions received by the first ion funnel, and at least a portion of the second plurality of intermediate electrodes receive a second RF voltage configured to confine ions received by the second ion funnel.

22. The ion funnel system of claim 21, wherein the first slope parameter is defined as half the difference between the first associated inner dimension of the first intermediate electrode and the first associated inner dimension of the adjacent first intermediate electrode divided by a distance between the first intermediate electrode and the adjacent first intermediate electrode, and the second slope parameter is defined as half the difference between the associated second inner dimension of the second intermediate electrode and the associated second inner dimension of the adjacent second intermediate electrode divided by a distance between the second intermediate electrode and the adjacent second intermediate electrode,

23. The ion funnel system of claim 21, comprising a length measured from the first entrance electrode to the first last electrode and a third slope parameter defined as half the difference between the first inner dimension and the second inner dimension divided by the first length, wherein the third slope parameter is less than 0.27.

24. The ion funnel system of claim 21, comprising an internal chamber defined by the first opening, the associated openings of the first plurality of intermediate electrodes, and the second opening, the internal chamber having an outer dimension reducing at a convergence angle from the first inner dimension to the second inner dimension, the convergence angle being less than 30 degrees for at least a majority of a length of the internal chamber,

25. The ion funnel system of claim 21, comprising a space between each of the first plurality of intermediate electrodes configured to permit gas to be extracted from the first ion funnel and a space between each of the second plurality of intermediate electrodes configured to permit gas to be extracted from the second ion funnel.

26. The ion funnel system of claim 21, comprising a conductance limit including an orifice, the conductance limit positioned adjacent the second last electrode and separating the second ion funnel from a downstream device having a pressure greater than a pressure of the second ion funnel, the greater pressure of the downstream device causing gas from the downstream device to enter the second ion funnel.

27. The ion funnel system of claim 26, wherein the second ion funnel is configured to generate an electric field that urges the ions through the orifice of the conductance limit and causes the ions to enter the downstream device.

28. The ion funnel system of claim 27, wherein the downstream device is an ion mobility device.

29. An ion funnel, comprising:
an entrance electrode;
a last electrode;
a plurality of intermediate electrodes positioned between the entrance electrode and the last electrode; and
an internal chamber having an outer dimension and a length, the outer dimension reducing at a convergence angle along the length of the internal chamber, the convergence angle being less than 30 degrees for at least a majority of the length of the internal chamber,
wherein at least a portion of the plurality of intermediate electrodes receive a radio frequency (RF) voltage configured to confine ions received by the ion funnel.

30. The ion funnel of claim 29, wherein the entrance electrode, the last electrode, and the plurality of intermediate electrodes are ring electrodes or plate electrodes, and the internal chamber is defined by the entrance electrode, the last electrode, and the intermediate electrodes.

31. The ion funnel of claim 29, wherein the entrance electrode, the last electrode, and the plurality of intermediate electrodes are formed on one or more printed circuit boards, and the internal chamber is defined by the one or more printed circuit boards.
